(19) United States
(12) Patent Application Publication
(10) Pub. No.: US 2008/0263323 A1
(43) Pub. Date: Oct. 23, 2008

(54) Reconfigurable Computing Architectures: Dynamic and Steering Vector Methods

(76) Inventors: Nick A. Mould, Norman, OK (US); John K. Antonio, Norman, OK (US); Monte P. Tull, Oklahoma City, OK (US); Brian F. Veale, Austin, TX (US); John R. Junger, Oklahoma City, OK (US)

Correspondence Address: DUNLAP CODDING, P.C., PO BOX 16370, OKLAHOMA CITY, OK, 73113, US

(21) Appl. No.: 12/102,621

(22) Filed: Apr. 14, 2008

Related U.S. Application Data
(60) Provisional application No. 60/923,461, filed on Apr. 13, 2007.

(51) Int. Cl. G06F 15/76; G06F 9/02

(52) U.S. Cl. 712/42; 712/E09.002

(57) ABSTRACT

A reconfigurable processor including a plurality of reconfigurable slots, a memory, an instruction queue, a configuration selection unit, and a configuration loader. The plurality of reconfigurable slots are capable of forming reconfigurable execution units. The memory stores a plurality of steering vector processing hardware configurations for configuring the reconfigurable execution units. The instruction queue stores a plurality of instructions to be executed by at least one of the reconfigurable execution units. The configuration selection unit analyzes the dependency of instructions stored in the instruction queue to determine an error metric value for each of the steering vector processing hardware configurations indicative of an ability of a reconfigurable slot configured with the steering vector processing hardware configuration to execute the instructions in the instruction queue, and chooses one of the steering vector processing hardware configurations based upon the error metric values. The configuration loader determines whether one or more of the reconfigurable slots are available and reconfigures at least one of the reconfigurable slots with at least a part of the chosen steering vector processing hardware configuration responsive to at least one of the reconfigurable slots being available.

### CROSS-REFERENCE TO RELATED APPLICATIONS

The present patent application claims priority to the provisional patent application identified by U.S. Ser. No. 60/923,461 filed on Apr. 13, 2007, the entire content of which is hereby incorporated herein by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE § 1.52(e)(5)). THE TOTAL NUMBER OF COMPACT DISCS INCLUDING DUPLICATES AND THE FILES ON EACH COMPACT DISC SHALL BE SPECIFIED

Not Applicable.

### BACKGROUND OF THE INVENTION

In one aspect, the present invention focuses on analyzing incoming instruction dependency information to identify both present and future instruction level parallelism (ILP). The analysis of instruction dependency information, in this work, relies heavily on a directed acyclic graph (DAG), represented in hardware as a dependency matrix and shown as a DAG in FIG. 10. In the past DAG analysis has been used to schedule tasks, usually made up of several blocks of instructions, onto a set of fixed processors. In accordance with the present invention, however, DAG analysis is used to make intelligent RFU loading decisions based on the identifiable ILP within a dependency matrix.

The present invention also draws from previously studied computing architectures capable of dynamic partial reconfiguration and for this reason the relevant existing literature is categorized into two areas: Reconfigurable Architectures, and Task Graph Scheduling Algorithms.

### RECONFIGURABLE ARCHITECTURES

In reference [1] three types of reconfigurable architectures are identified: attached processor, co-processor, and functional unit. The work presented in this patent application builds on that in reference [1] related to architectures of the functional unit paradigm including OneChip, SPYDER, and PRISC. See references [13, 14, 15].

The functional unit architecture of reference [1] is specifically designed as a general purpose computing architecture capable of executing both modern and legacy code. Niyonkuru—reference [3]—introduces a partially reconfigurable architecture that loads predefined configurations of RFUs based on the information contained within its trace cache. Veale—reference [1]—improves on this architecture by adding the ability of the vectors to be partially loaded, and also introduces a method of scoring the available configuration steering vectors based on the incoming instructions in the instruction buffer rather than with a trace cache as proposed in reference [3]. The work in both references [1] and [2] are based on superscalar architectures that maintain a set of fixed functional units (FFUS) to prevent instruction resource starvation. The loading of vectors containing RFUs is simply a means of adding additional functional units to take advantage of instruction level parallelism (ILP).

The dynamic vector approach of the present invention builds onto the superscalar functional unit architectures of reference [1]. However, this new method loads individual RFUs into a configuration space rather than predefined steering vectors of RFUs as in reference [1]. Determining the RFUs to load at any given time is preferably based on a “level” analysis of the DAG derived from the instructions residing in the instruction buffer.

### Task Graph Scheduling Algorithms

The challenge of mapping a set of changing tasks from an acyclic task graph to a set of fixed resources has been studied extensively as a mathematical problem in reference [4] and a scheduling problem in references [5-8]. Although the work presented in this patent application makes use of the research in previous task graph analysis, it is not preferably used solely for instruction scheduling. Instead, the analysis method is used to determine the present and future RFU resource needs, and then this information is used to either load or discard specific RFUs or vectors thereof.

Previous work in reference [4] has shown that efficient mapping of a task graph to a fixed set of resources is an NP-Complete problem. However, efficient mapping of tasks to a set of resources is highly desirable in parallel computing applications, and has led to the development of a large number of heuristic solution attempts.

In the previous work, task graphs are used to represent computing needs, where each node represents either single or multiple instructions. See references [5-8]. In any case, a directed acyclic graph may be used to represent either single instructions in a machine or variable sized blocks of instructions, commonly referred to as tasks. The many approaches to the problem of mapping tasks to resources are all based solely on the DAG and the resources available.

In the case of homogeneous resources only a single queue is required. Each task in the graph is assigned a priority, and then each task is placed into the queue based on its priority. The priority analysis can be as simple or complex as desired, but is often based on the earliest start time and finish time of the task in conjunction with the execution time required by the task. If a great deal of information regarding each task is available, then certainly a more complicated analysis will lead to a better priority calculation, resulting in a smoother task execution schedule. See references [5-8]. Dynamic Priority Scheduling (DPS) as described in reference [5], Dynamic Level Scheduling (DLS) as described in reference [6] are both examples of scheduling algorithms that involve a priority calculation based upon earliest start time, execution time, and a set deadline for each task. Shang, i.e., reference [7], introduces an evolutionary algorithm that is similar in priority calculation to DPS and DLS and also factors in the cost of reconfiguration overhead (time). In the case of heterogeneous resources many queues may be required, depending on the difference in functional capability of each resource available. DPS and DLS are both examples of priority scheduling algorithms for mapping a DAG to a set of heterogeneous resources. See references [5, and 6] for example.

In addition to algorithms for task graph analysis, we are also interested in hardware implementations of task graph schedulers. Beckmann, i.e., reference [8], defines two hardware implementations of a task graph scheduler that is used to keep track of inter-instruction dependencies. This problem is applicable to the implementation of a superscalar in the sense that ready instructions should be given higher scheduling priority than those with unsatisfied dependencies. The specific priority calculations of interest are those that are calculated dynamically, specifically those that can easily be modified to identify ILP within both present and future instructions as in references [5-8]. The interest in dynamic calculations is of importance from a reconfigurable FPGA design standpoint, because reconfigurable designs will require that calculations and RFU loading decisions be performed dynamically to suit the needs of a quickly changing instruction buffer.

As stated earlier, the dynamic vector approach, in accordance with the present invention, analyzes the DAG to determine the appropriate set of resources necessary for exploiting the ILP identified from an instruction buffer. Therefore, this research builds on the dynamic scheduling analysis algorithms of references [5-8] and the concepts of “levelized” scheduling introduced in reference [9].

### BRIEF SUMMARY OF THE INVENTION

The present invention is directed to improvements in the performance and algorithms associated with two competing module-based reconfigurable superscalar computing architectures. The “Steering Vector” method described in reference [1] is partially evaluated both mathematically and through simulation. Hybrid reconfigurable functional unit (RFU) combinations that form during execution of the steering vector method are mathematically studied to better understand the design requirements necessary for designing reconfigurable modules (vectors of RFUs). Alternative loading strategies were explored and scoring strategies associated with the alternative reconfiguration schemes, leading to the development of the dynamic vector method. The dynamic vector method is also explored mathematically in the area of task graph scheduling, and a new and improved configuration selection and loading scheme has been developed. The dynamic vector method further improves on the steering vector method in that the various RFUs may be loaded in any available configuration slot(s).

In particular, certain aspects of the present invention explore the areas of reconfigurable computing that focus on dynamic loading of reconfigurable functional units (RFUs) and the subsequent instruction scheduling onto the then configured RFUs. The specific challenge addressed is the design of a control unit that loads and discards RFUs within a configuration space based on a table of incoming program instructions. Two recent methods; the steering vector method described in reference [1], and the newer dynamic vector method described in reference [2], are evaluated. The goal of the research is to develop an intelligent control unit algorithm, the dynamic “steering vector” method, measured by its ability to exploit instruction level parallelism and efficiently utilize the available configuration space in such a way that reconfiguration time becomes insignificant. The motivation for this work is to enhance general purpose computing applications as well as remaining legacy compatible, and to contribute algorithmically to the future needs of situational aware computing.

The present invention makes contributions in the area of partially reconfigurable computing architectures, specifically to the steering vector method described in reference [1] and the newer dynamic vector method of reference [2]. The steering vector method of reference [1] employs a superscalar architecture derived from reference [3] where reconfigurable functional units (RFUs) such as integer ALUs and floating point multiply/dividers are reconfigured during runtime to facilitate the exploitation of instruction level parallelism (ILP). Initially described in reference [3], configurations of RFUs are predefined in contiguous memory blocks, but as further refined in reference [1] they are redesigned as partially reconfigurable steering vectors; i.e., steering vectors may partially load to suit the availability provided within the configuration space. Veale [1] expands on the architecture of reference [3] by making the steering vectors partially reconfigurable so that hybrid RFU configurations not described in the predefined steering vectors can be dynamically formed during runtime.

Research inspired by the steering vector method of reference [1] is (1) an in-depth analysis of the steering vector selection and loading strategy and (2) a mathematical approach to understanding the complexity of the configuration space for the purposes of designing steering vector RFU combinations.

The precursor of the steering vector method described in reference [3] proposes the use of a trace cache to determine the best RFU configuration to load at any given time, and the steering vector method details an error metric calculation to best match the needs of the instructions in the buffer to one of the predefined steering vectors. The error metric calculation of reference [1] applies to the instructions in the instruction buffer (e.g., all instructions in the instruction buffer), including those that have already been issued. The present invention explores several alternative-scoring methods that operate on different subsets of instructions within the instruction buffer, such as scoring only “ready” instructions or scoring only instructions that have not been issued.

Both references [1] and [3] identify several predefined RFU configurations but fail to rigorously evaluate the performance of the initially proposed steering vectors. The work of the present invention mathematically explores the configuration space by identifying the unique RFU combinations that are possible for a specific configuration space based on the size of the configuration space and the sizes and types of possible RFUs. Also, a set of guidelines for designing steering vectors capable of forming, for example, all of the possible RFU combinations via partial reconfiguration are set forth.

Simulation results obtained from a custom software simulator designed specifically for simulating the steering vector and dynamic vector architectures revealed several limitations of the steering vector method as described in [1]. The limitations of the steering vector method identified are:

RFUs are unnecessarily loaded owing to the architecture of the machine

RFUs that are valuable in the immediate future are discarded, only to be replaced by RFUs that have no immediate value

Various steering vector scoring methods fail to differentiate themselves with respect to total clock cycles.

In accordance with the present invention, a proposed solution to the steering vector scoring problem is to further segregate the instructions into subsets based on their level within a directed acyclic graph representative of the instruction buffer. The instructions within the buffer are then sorted into dependency levels, and the RFU need of each level is computed and then passed onto a loading scheme that allows RFUs to be loaded individually into any location in the configuration space. The RFUs that are already configured are then evaluated based on the computed RFU need for each dependency level, and their future usability is assessed so that valuable RFUs are not discarded, effectively creating a dynamic priority loading and discarding process.

The dynamic vector method of reference [2] makes use of both the configuration space complexity results and the data obtained from simulating the steering vector approach with many different steering vector selection techniques. The dynamic vector method is the main contribution of this research and builds heavily on the work in reference [1] and in itself contains further contributions such as a unique level analysis procedure and a priority based dynamic vector update procedure. The ultimate goal of this work will be to realize the dynamic vector method in a dynamically reconfigurable field programmable gate array (FPGA). The design of the level analysis procedure in conjunction with the RFU need calculation as a combinational circuit will facilitate the, “on-the-fly,” creation of either a partial or complete RFU vector that can then be loaded into the available configuration slots. Finally, the dynamic vector can then be tested in a true high performance hardware application, perhaps in a high performance reconfigurable device.

In another version of the present invention, an architectural framework is studied that can perform dynamic reconfiguration. A basic objective is to dynamically reconfigure the architecture so that its configuration is well matched with the current computational requirements. The reconfigurable resources of the architecture are partitioned into N slots. The configuration bits for each slot are provided through a connection to one of N independent busses, where each bus can select from among K configurations for each slot. Increasing the value of K can increase the number of configurations that the architecture can reach, but at the expense of more hardware complexity to construct the busses. Our study reveals that it is often possible for the architecture to closely track ideal desired configurations even when K is relatively small (e.g., two or four). The input configurations to the collection of busses are defined as steering vectors; thus, there are K steering vectors, each having N equal sized partitions of configuration bits. In accordance with the present invention, a combinatorial approach is introduced for designing steering vectors that enables the designer to evaluate trade-offs between performance and hardware complexity associated with the busses.

In this patent application, a framework for a dynamically reconfigurable architecture is described, which includes an interconnection scheme between steering vectors and the reconfigurable resources, described earlier in references [1-3]. The framework is relatively generic and can be applied to model a number of existing approaches for dynamic reconfiguration. For example, it is applicable to instruction-level architectures in which the functional units of a superscalar processor are assumed to be able to be dynamically reconfigured. See for example references [1 and 2]. It is also applicable to task-level architectures in which dynamic reconfiguration is used to support higher-level computations such as signal processing [20] or data compression [21].

### BRIEF DESCRIPTION OF THE SEVERAL VIEWS OF THE DRAWING

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a partially run-time reconfigurable architecture for a reconfigurable processor utilized in accordance with exemplary embodiments of the present invention.

Table 1 illustrates a number of exemplary types of functional units, and their encodings, provided in fixed and reconfigurable portions of the reconfigurable architecture depicted in FIG. 1.

FIG. 2 is a block diagram of an exemplary configuration selection unit constructed in accordance with the present invention.

FIGS. 3(a), 3(b) and 3(c) cooperate to illustrate an exemplary method of generating configuration error metric values, more particularly,

FIG. 3(a) is a diagram of an exemplary error metric equation;

FIG. 3(b) is a schematic diagram of an exemplary error metric computation circuit; and

FIG. 3(c) is a schematic diagram of an exemplary circuit for the inputs to the shifter units.

FIG. 4 is a dependency graph showing the dependencies between entries of the instruction queue.

FIG. 5 is a wake-up array showing the entries for the instructions depicted in FIG. 4.

FIG. 6 is a logic flow diagram illustrating the logic associated with one resource vector of the wake-up array of FIG. 5.

FIG. 7 is a schematic diagram of an exemplary circuit that computes the availability of a resource of type t as specified in Equation 1.

FIG. 8 shows initial basis vectors for five RFU types <A, B, C, D, E> with corresponding sizes <1, 2, 2, 3, 3> and a configuration space size of eight.

FIG. 9 shows exemplary initial basis vectors with additional RFUs illustrating a proper use of empty space in accordance with the present invention.

FIG. 10 shows an example directed acyclic graph (DAG) with corresponding RFU need calculated both with and without dependency level consideration.

FIG. 11 is a schematic diagram of a dynamic vector method architecture constructed in accordance with the present invention.

FIG. 12 illustrates pseudo-code for a dynamic vector update procedure developed and utilized in accordance with the present invention.

FIG. 13 is a schematic diagram of a conceptual framework for a dynamically reconfigurable architecture with K=2 steering vectors, N=5 reconfigurable slots, and busses of width W.

FIG. 14 illustrates a same conceptual framework as shown in FIG. 13, but with modified steering vectors.

Table 2 illustrates simulation results showing cycle counts associated with configurations to exploit available parallelism. Configurations utilizing <5 slots are noted with “−” and those requiring >5 slots are noted with a “+”.

### DETAILED DESCRIPTION OF THE INVENTION

Presently preferred embodiments of the invention are shown in the above-identified figures and described in detail below. In describing the preferred embodiments, like or identical reference numerals are used to identify common or similar elements. The figures are not necessarily to scale and certain features and certain views of the figures may be shown exaggerated in scale or in schematic in the interest of clarity and conciseness.

1. Overview of the Architecture

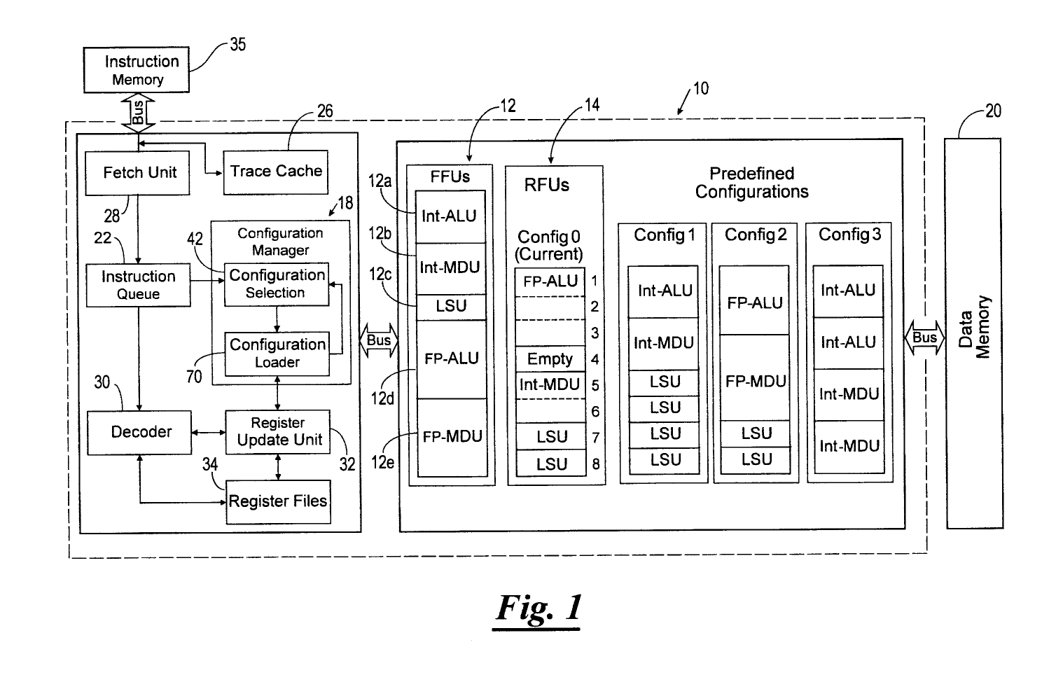

Referring now to the drawings, and in particular to FIG. 1, shown therein and designated by a reference numeral 10 is an architecture for a reconfigurable superscalar processor (hereinafter referred to herein as “processor 10”) constructed in accordance with the present invention. The processor 10 has one or more fixed functional (or execution) units 12, and one or more reconfigurable functional (or execution) units 14. The reconfigurable execution units 14 are implemented in reconfigurable hardware. By way of example, the processor 10 depicted in FIG. 1 is provided with five fixed execution units designated by the reference numerals 12a, 12b, 12c, 12d and 12e for purposes of clarity, and six reconfigurable execution units designated by the reference numerals 14a, 14b, 14c, 14d, 14e and 14f for purposes of clarity. It should be understood that the processor 10 can be provided with more or less fixed execution units 12 or reconfigurable execution units 14.

The overall configuration of the processor 10 is defined according to how its reconfigurable execution units 14 are configured. The processor 10 is provided with a configuration manager 18 which first selects the best matched among a plurality of steering configurations (e.g., stored in a data memory 20, or a special memory capable of fast “context switching”) based on the number and type of reconfigurable or fixed execution units 14 and 12 required by instructions in an instruction queue or buffer 22. The instruction queue or buffer 22 is a data structure where instructions are lined up for execution. The order in which the processor 10 executes the instructions in the instruction queue or buffer 22 can vary and will depend upon a priority system being used.

In a preferred embodiment, configuration 0 (shown in FIG. 1 with the label “Config 0”) is dynamically defined as the current configuration; the other configurations are statically predefined (three being shown in FIG. 1 for purposes of brevity and labeled as Config 1, Config 2 and Config 3). Once a steering configuration is selected, portions of it begin loading on corresponding reconfigurable execution units 14 that are not busy. For example, the steering configuration can begin loading into one or more slots of reconfigurable space for the benefit of one or more reconfigurable execution units 14. The active or current configuration of the processor 10 is generally the overlap of two or more steering configurations.

FIG. 1 shows the partially run-time reconfigurable architecture considered in this patent. Because some of the functional units of the processor 10 are reconfigurable, the architecture is within the RFU paradigm discussed in the previous section. A collection of five fixed functional units (FFUs) 12a-e and eight RFU “slots” are provided as an illustrative basis for the architecture discussed in this patent. The RFU slots are shown by way of example in FIG. 1 as configured to provide four RFUs 14 and with one reconfigurable slot empty. In the Example shown in FIG. 1, three of the reconfigurable slots are configured to provide a FP-ALU functional unit, two of the reconfigurable slots are configured to provide a Int-MDU functional unit, and two of the reconfigurable slots are configured to provide two LSU functional units. In general, the size of the smallest slot is preferably determined by the size of the smallest RFU 14 to be loaded. Preferably parts of the predefined configurations are loaded in contiguous reconfigurable slots matching the size requirements of the RFU. More or fewer FFUs 12 and/or RFU slots could be used without affecting the invention described here. As the processor 10 executes instructions, it reconfigures RFUs 14 that are not busy to best match the needs of the instructions that are in the instruction queue 22 and are ready to be executed.

The architecture given in FIG. 1 includes a plurality of predefined configurations for the reconfigurable functional units 14. In the example depicted in FIG. 1, four different predefined steering configurations are shown, i.e., the current steering configuration (indicated as Config 0), and three other predefined steering configurations (indicated as Config 1, Config 2 and Config 3) The RFUs 14 can be reconfigured independently of each other using partial reconfiguration techniques, thereby allowing the processor 10 to implement the current configuration (Config 0) that is a hybrid combination of the predefined configurations. Thus, the current configuration may or may not correspond exactly to one of the predefined steering configurations. Predefined steering configurations provide a basis for selecting a steering vector for the reconfiguration.

This approach is an extension of the teachings of reference [7] set forth below, where the use of partial reconfiguration at the level of the reconfigurable functional units 14 was not directly addressed. Also, the idea of implementing one of each type of functional unit in fixed hardware was not specified. However, the basic architectural structure assumed in this patent is similar to that described in reference [7].

Each predefined steering configuration specifies zero or more integer arithmetic/logic units (Int-ALU), integer multiply/divide units (Int-MDU), load/store units (LSU), floating-point arithmetic/logic units (FP-ALU), and/or floating-point multiply/divide units (FP-MDU). The types of execution units are not limited to these types and may consist of finer-grained units such as barrel shifters and specialized logic or arithmetic units, or coarser-grained units such as multiply and accumulate units. Table 1 is an exemplary break down of how many functional units of each type are provided by each steering configuration including the number of each that is provided as a fixed unit. It should be noted that the granularity of the functional units can be generalized to be either finer (e.g., smaller units) or coarser (e.g., larger units) than what is assumed here. For the purposes of the present description, it is assumed that each instruction is supported by exactly one type of functional unit. However, the invention also extends to situations in which two or more execution units are capable of executing a common instruction. Furthermore, for the discussion here, only one execution unit is assigned for the execution of each instruction and that unit handles all micro-operations necessary to execute that instruction, i.e., two or more different execution units are not required for the execution of any instruction. However, the invention also extends to this case as well.

In addition to the fixed functional units 12, the processor 10 is also provided with a plurality of fixed modules. In the example shown in FIG. 1, other fixed modules of the architecture provide the instruction queue 22, the data memory 20, a trace cache 26, an instruction fetch unit 28, an instruction decoder 30, a register update unit 32, a register file 34, an instruction memory 35 and the configuration manager 18. The instruction fetch unit 28 fetches instructions from the instruction memory 35 and provides them to the instruction queue 22. The configuration manager 18 preferably uses a unit decoder 40 similar to the pre-decoder of reference [7] to retrieve the instruction opcodes from the instruction queue 22. The instruction opcodes are then used to determine the functional unit resources required. The trace cache 26 is used to hold instructions that are frequently executed. As described in more detail in reference [7], the trace cache 26 and the pre-decoding unit 30 are used to determine the resources required to execute instructions at run time. As described in section 2 the configuration manager 18 includes a configuration selection unit 42 that matches instructions that are ready to be executed with the functional units they require and (partially) reconfigures the reconfigurable functional units of the processor 10 to match the needs of these instructions. This configuration selection unit 42 can be used (to fulfill the requirements) for the pre-decoders and configuration manager envisioned in reference [7].

The instructions (i.e. software) have long term storage in the instruction memory 35 (large memory space, but slow access). Instructions that are believed to be fetched in the near future are cached to the instruction queue 22. Instructions that are believed to be executed in the near future are fetched from the instruction memory 35 and placed into the instruction queue 22, where the configuration selection unit 42 uses these instructions in its decoding action.

The register update unit 32 collects decoded instructions from the instruction queue 22 and dispatches them to the various functional units 12 and 14 configured in the processor 10. The register update unit 32 also resolves all dependencies that occur between instructions and registers. A dependency buffer (not shown) is included in the register update unit 32 that keeps track of the dependencies between instructions and registers. The register update unit 32 writes computation results back to the register file during the write-back stage of instruction execution. Furthermore, the register update unit 32 allows the processor 10 to perform out-of-order execution of instructions, in-order completion of instructions, and operand forwarding see reference [7], for example.

2. Configuration Selection and Loading

2.1 Configuration Selection

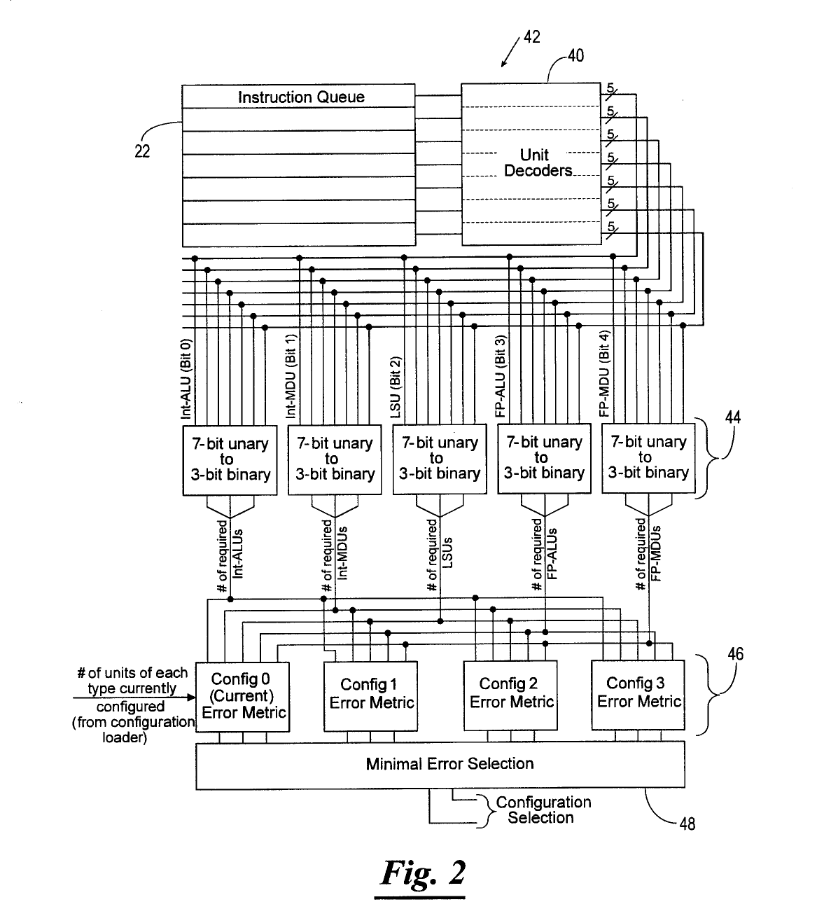

The configuration selection unit 42 is shown in FIG. 2. The configuration selection unit 42 inspects the instructions in the instruction queue 22 that are ready to be executed and chooses one of the plurality of steering configurations. In the example depicted in FIG. 1, three of the steering configurations are predefined steering configurations; the remaining steering configuration represents the currently active configuration (see Table 1). The current steering configuration may or may not correspond exactly to one of the predefined steering configurations because partial reconfiguration is employed when transitioning between configurations. Thus, the current configuration may be a hybrid combination of two or more predefined steering configurations. The configuration selection unit 42 considers the possibility that the current configuration may be better matched to the instructions requesting resources than any of the predefined steering configurations. In fact, achieving a stable and well-matched current steering configuration is desirable because it implies that the architecture has settled into a configuration state that matches the requirements of the software code.

The configuration selection unit 42 consists of four stages: (1) the unit decoders 40, (2) resource requirements encoders 44, (3) configuration error metric generators 46, and (4) one or more minimal error selection units 48. The inputs to the minimal error selection unit 48 are the instruction queue 22 and one or more codes indicative of the number of each type of reconfigurable functional units 14 currently configured in the processor 10. The output of the minimal error selection unit 48 is a code, such as a two-bit value that indicates which of the steering configurations (e.g., three predefined RFU configurations or the current configuration) should be configured next. If more than four steering configurations are employed, then more than two bits would be required to encode the steering configurations, e.g., if selection is made from among five to eight configurations, then the minimal error selection unit 48 would output a three-bit value.

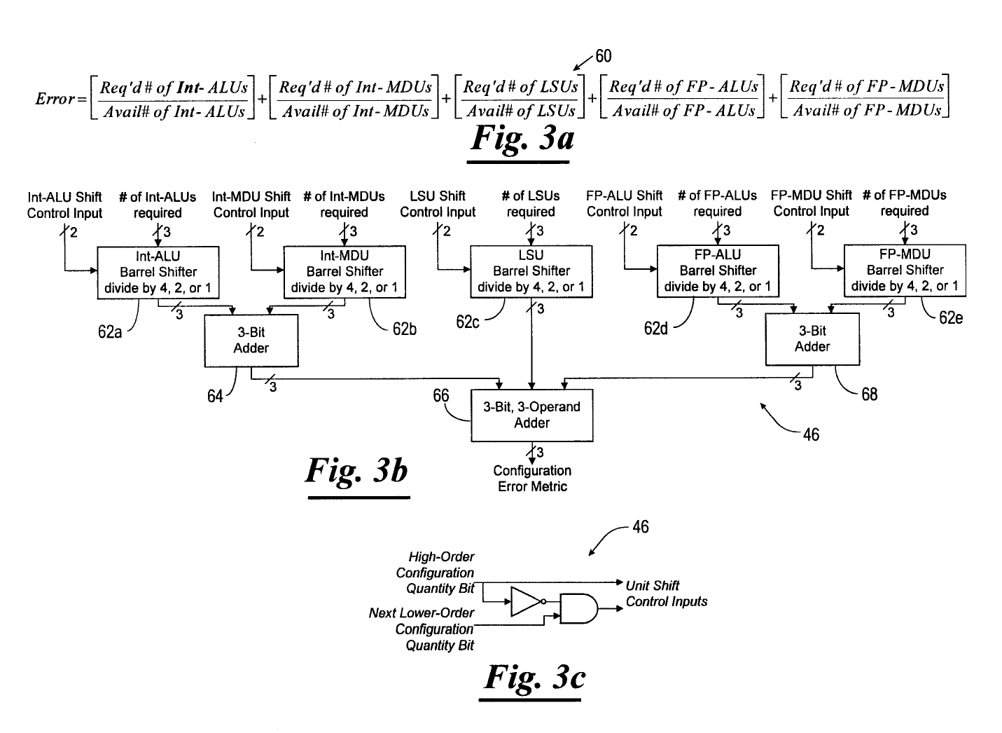

The unit decoders 40 serve the same purpose as the pre-decoders of the original architecture specified in reference [7]. The unit decoders 40 retrieve the opcode of each instruction in the instruction queue 22 that is ready for execution. The output of each unit decoder 40 is preferably a one-hot vector that indicates the functional unit (i.e., reconfigurable or fixed or either) required by the instruction whose opcode the unit decoders 40 decoded. This information is collected from all unit decoders 40 and transformed into a three-bit binary value by the resource requirement encoders 44 that indicates how many functional units of each type, e.g., Int-ALU, Int-MDU, LSU, FP-ALU, and FP-MDU are required to execute a group, such as all, of the instructions in the instruction queue 22. The configuration error metric generators 46 then determine how close each of the three predefined configurations and the current configuration are to providing the resources required by the instructions in the instruction queue 22. Finally, the minimal error selection unit 48 (e.g., shown in FIG. 3(c)) uses the error associated with each configuration to choose the configuration that most closely meets the needs of the instructions in the instruction queue 22.

The configuration error metric generators 46 calculate an error metric value that indicates the error or “closeness” of the number and type of functional units (i.e., reconfigurable or fixed) required to execute the instructions in the instruction queue 22 relative to each of the four configurations; the FFUs are included in this calculation. The function that each error configuration metric generator 46 implements is defined by the equation given in FIG. 3(a).

The configuration error metric generators 46 (CEM) of FIG. 3(b) accept the quantified configuration resources for the predefined configurations, as well as the current configuration. The CEM 46 shown in FIG. 3(b) implements an equation 60 of FIG. 3(a) to produce the error metric value for each of the configurations, including the current configuration. The CEM 46 of FIG. 3(b) includes a plurality of combinational divider circuits 62 (five being shown and designated by the reference numerals 62a, 62b, 62c, 62d and 62e) to form the ratios in the equation 60 depicted in FIG. 3(a). In the example depicted in FIG. 3(b), the combinational divider circuits 62 are implemented with a plurality of barrel shifters which approximate the ratios by shifting (or not shifting which is divide by 1) the binary input to the right, thereby dividing the input by 2, 4, 8, etc. The barrel shifters depicted in FIG. 3(b) for the three or more predefined configurations can be arranged with hard-wired shift control inputs to divide by 4, 2, or 1, because the number of units associated with the divisor of each division calculation associated with these configurations are known, i.e., they are predefined. The barrel shifters for the current configuration use shift control inputs based on the upper two bits of the quantity of currently configured reconfigurable functional units 14.

FIG. 3(b) shows how the upper two bits are treated to approximate division of the functional unit requirement using 4, 2, or 1 as the divisor. A more accurate divider circuit could be implemented, if desired, at the expense of increased complexity and latency. Because the total number of fixed and reconfigurable functional units 12 and 14 required for this architecture does not exceed seven (the instruction queue 22 is assumed to hold seven instructions), three-bit adders 64, 66 and 68 are sufficient for summing the total error metric value. Employing a larger buffer would correspondingly require more bits for encoding and larger adder circuits.

The minimal error selection unit 48 of the configuration selection unit 42 chooses a configuration that achieves a minimal error by outputting the error metric value, for example, a two-bit binary value that represents the configuration that should begin loading. The novelty in this process is handling the case where a RFU 14 is currently executing a multi-cycle instruction, in this situation the loading of the selected configuration is not stalled, rather, reconfiguring the RFUs 14 that are not busy takes place.

In cases where the smallest configuration errors are equal, the minimal error selection unit 48 is designed to identify the configuration that requires the least amount of reconfiguration. Thus, if the error metric value for the current configuration is smallest, then it will ultimately be selected over a predefined configuration having the same error metric value. The current configuration is preferably favored over any predefined steering configuration that has the same error metric value. In a preferred embodiment, the current configuration is always favored over any predefined steering configuration that has the same error metric value because reconfiguration requires time overhead. If the current configuration does not achieve the minimal error metric value, and two or more predefined configurations do achieve the same minimal error metric value, then the predefined configuration ultimately selected will be the one that requires the least amount of reconfiguration relative to the current configuration.

2.2 Configuration Loading

The configuration selection unit 42 of FIG. 2 determines the configuration that should be loaded into the processor 10 to execute the instructions in the instruction queue 22 that have not been scheduled. If the configuration selection unit 42 chooses the current configuration, then the configuration loader 70 will not reconfigure any of the RFUs 14. Additionally, the configuration loader 70 tracks what type of functional unit is configured into each slot of reconfigurable hardware. This is handled by storing a resource allocation vector that contains this information. Each of the fixed or reconfigurable functional unit types supported by the architecture, e.g., Int-ALU, Int-MDU, LSU, FP-ALU, FPU-MDU, are given an encoding, such as a three-bit encoding, specified in Table 1. Because each reconfigurable functional unit 14 can occupy one or more slots of reconfigurable hardware available in the processor 10, a special encoding is used to indicate that a slot contains a portion of a functional unit that spans two or more slots. The first entry of the resource allocation vector for a unit that spans multiple slots contains that block's encoding, and the following entries contain, for example, the special encoding of 111₂. Of course the number of bits in these encodings increases as necessary if more types of units are employed.

Once a configuration is chosen, the configuration loader 70 will determine which RFUs 14 need to be reconfigured. In one embodiment, the configuration loader 70 determines the difference (XOR) between the chosen configuration and the current configuration using the resource allocation vector. The configuration loader 70 will then choose which RFUs 14 to reconfigure on the basis of their availability. If the RFU 14 is executing a multi-cycle instruction, the RFU 14 cannot be reconfigured until the instruction finishes execution and is retired (and by the time it is available for reconfiguration, a different configuration may have been selected). To accommodate this approach, each slot has an available port that is asserted when the RFU 14 it implements is available, i.e., not busy. The configuration loader 70 can determine if a RFU 14 can be reconfigured by inspecting this output from the corresponding slot.

If the RFU 14 (and the slots it occupies) is available and it must be reconfigured to implement a new steering configuration, then the configuration loader 70 will reconfigure the slots for the RFU 14 to implement the functional unit specified by the chosen steering configuration. The RFU 14 will not be reconfigured if it already implements the specified functional unit (i.e., the type of the unit currently implemented in the RFU 14 matches the type specified in the chosen configuration). This reconfiguration is performed using partial reconfiguration techniques, such as those discussed in reference [8].

Due to the possibility that some RFUs 14 may be busy and not be reconfigured to implement a functional unit defined by the chosen steering configuration, certain instructions may not be able to execute for several cycles. This problem would be compounded if FFUs 12 were not provided as a part of the architecture and the processor 10 entered a state where certain functional units were not implemented for long periods of time. With the present architecture, the FFUs 12 desirably implement units for all instructions so that every instruction is guaranteed to execute. However, the processor 10 could be implemented without any FFUs 12.

1.

3. Instruction Scheduling and Execution

An integral challenge in the design of a dynamically partial reconfigurable processor 10 is the scheduling, execution, and retirement of instructions. As the processor 10 changes the configuration of its RFUs 14 to best match the instructions being executed, the processor 10 must be able to determine what resources are available to support the execution of instructions. If the processor 10 chooses to schedule instructions for which there are not enough resources, then those instructions' execution can be delayed waiting for the required resources to become available.

To solve this problem, we employ a scheduling approach that preferably uses a wake-up array that allows instructions to “wake up” when the necessary functional units are available and required results from previous instructions are available, such as those arrays taught by reference [9]. This section discusses the basic approach and presents how the availability of RFUs 14 can be dynamically determined. Note that reference [9] presents a more sophisticated scheduling approach than discussed here; however, our approach can be extended using the same techniques that are employed in reference [9].

3.1 Scheduling Using Wake-Up Arrays

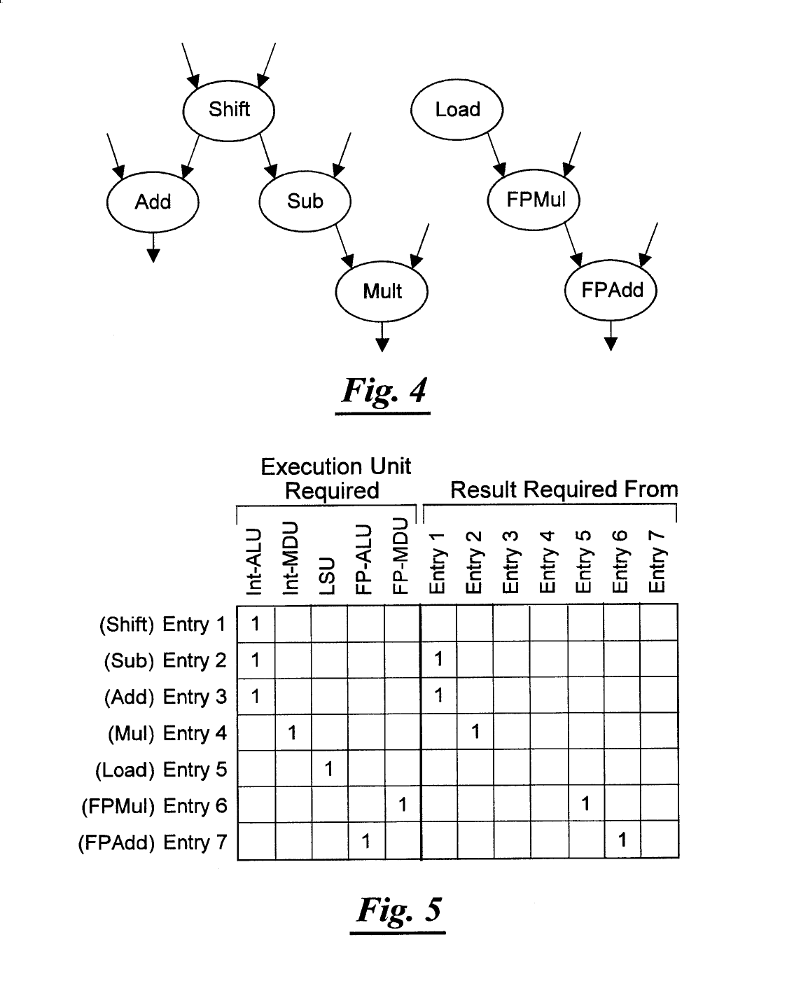

The wake-up array contains information that allows the scheduling logic to match the functional units that are not busy to instructions that are ready to execute. This includes determining if the instruction requires results from any previous instructions and verifying that the results from those previous instructions are available. Specifically, the wake-up array consists of a set of resource vectors that encode which functional unit an instruction requires and the instructions that must produce results before the instruction can be executed see reference [9], for example. An example of a dependency graph for a set of instructions and the corresponding wake-up array are presented in FIGS. 4 and 5. Note that there must be a “result required from” column in the array for each row (instruction entry) of the array. This column reflects the dependencies of subsequent instructions on any previous instructions.

In the example of FIGS. 4 and 5, the Load instruction (Entry 5) only requires the load-store unit 12c, so only the resource bit for the load-store unit 12c is set on the row for the Load instruction. Additionally, the Load instruction does not depend on the result of any other instructions, so the column entries for the other instructions in the array are not set. Recall that for the RISC architecture assumed here, an instruction will never require more than one functional unit. In the current embodiment, it is assumed that each instruction requires one and only one functional unit to handle its entire execution. However, there are alternatives such as by connecting multiple execution units together to execute several instructions in a data-flow architecture. The Multiply instruction (Entry 4) uses an integer multiplier (Int-MDU) and requires a result from the Subtract instruction (Entry 3); therefore, the bits for Entry 4 are set in the columns for the Int-MDU unit and Entry 3.

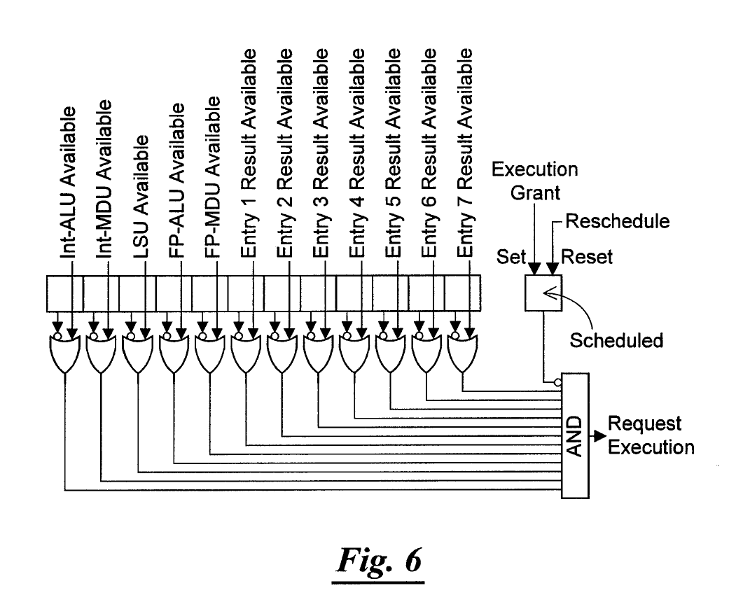

FIG. 6 shows the logic associated with the wake-up array of FIG. 5 that determines if the instruction represented by each entry of the wake-up array should be considered for release by the scheduling logic. The wake-up logic only determines when an instruction is ready for execution and generates an execution request for those instructions that are ready and does not actually determine if an instruction is scheduled because multiple instructions could require the same resources. This contention between instructions must be handled by the scheduler after multiple instructions that use the same resources request execution.

The “available” lines shown in FIG. 6 indicate whether the corresponding resource or the results of the corresponding entry in the array are available; the value of each line is high if the resource/result is available. These lines pass through every entry in the array and enter an OR gate that checks if the resource/result is needed and available. See reference [9] for example. If the resource is not required, then the output of the OR gate must be high in order for the entry to be scheduled when the resources/entries that are required are available. Each of these results are ANDed together to ensure that every resource and entry required is available. See reference [9] for example. The logic required to compute resource availability in a static fixed logic processor having only FFUs 12 is more straightforward than for a reconfigurable processor having both FFUs 12 and RFUs 14 where the logic that determines the availability of a resource should desirably consider not only if the resource is busy but also if the resource is currently configured into the system. The scheduled bit, shown in FIG. 6, is required to keep an instruction from requesting execution once it has been scheduled, since instructions may take several cycles to complete. See reference [9] for example. Instruction entries in the wake-up array are not removed until the instruction is retired to keep instructions that rely on the result(s) of the instructions currently being executed from requesting execution too early. After an instruction receives an execution grant, its corresponding available line is asserted at the time that its result will be available. This can be handled using a count down timer that is set to the latency of the instruction. If the instruction has a latency of N cycles, the count down timer will be set to N−1; if the instruction has a one-cycle latency, the available line is asserted immediately. An instruction's timer will start once the instruction receives an instruction grant and the instruction's available line is asserted once the timer reaches a count of one. Once an instruction finishes execution and is retired, every wake-up array entry associated with the instruction is cleared to keep new instructions that are added to the wake-up array from incorrectly becoming dependent on the retired instruction. This approach also handles the case of an instruction being removed from the array before its dependent instructions are scheduled by allowing these instructions to request execution without considering a dependence on the retired instruction. If an instruction must be rescheduled, then the schedule bit is de-asserted using the reschedule input of the scheduled bit as described in reference [9].

3.2 Computation of Resource Availability

In order to use the wake-up array approach to scheduling instructions, the processor 10 must include logic that determines which functional units (resources in the wake-up array) are available. This can be handled by allowing each resource to assert whether it is available. If there are multiple resources of the same type, then their availability assertions must be ORed to ensure that the availability line in the wake-up logic for the resource is asserted. Determining if a resource is available is more difficult in a reconfigurable processor 10 because of the dynamic nature of which resources can be configured into the processor 10 at any given point in time.

The availability of a resource is a function of the allocation of the resource and availability of each copy of the resource that is configured into the processor 10. The availability of each resource can be determined using a signal from each slot of reconfigurable hardware that indicates if the functional unit it implements is busy or available. This availability signal is asserted when the functional unit is available. Equation 1 defines the calculation of an available function that determines if a functional unit of a particular type is available using the availability signal of each slot and the resource allocation vector provided by the configuration loader that specifies the type of functional unit implemented by each RFU 14 and FFU 12 provided in the processor 10. In Equation 1, type(i) refers to the encoding of a functional unit of type t, specified in Table 1.

$$available ( t ) = {\sum }_{{i ∈ resource}_{allocation vector}} ( {\prod }_{b ∈ [ 0 , 2 ]} \overline{( {type ( t )}_{b} ⊕ {type ( i )}_{b} )} ) \cdot availability \qquad ( 1 )$$

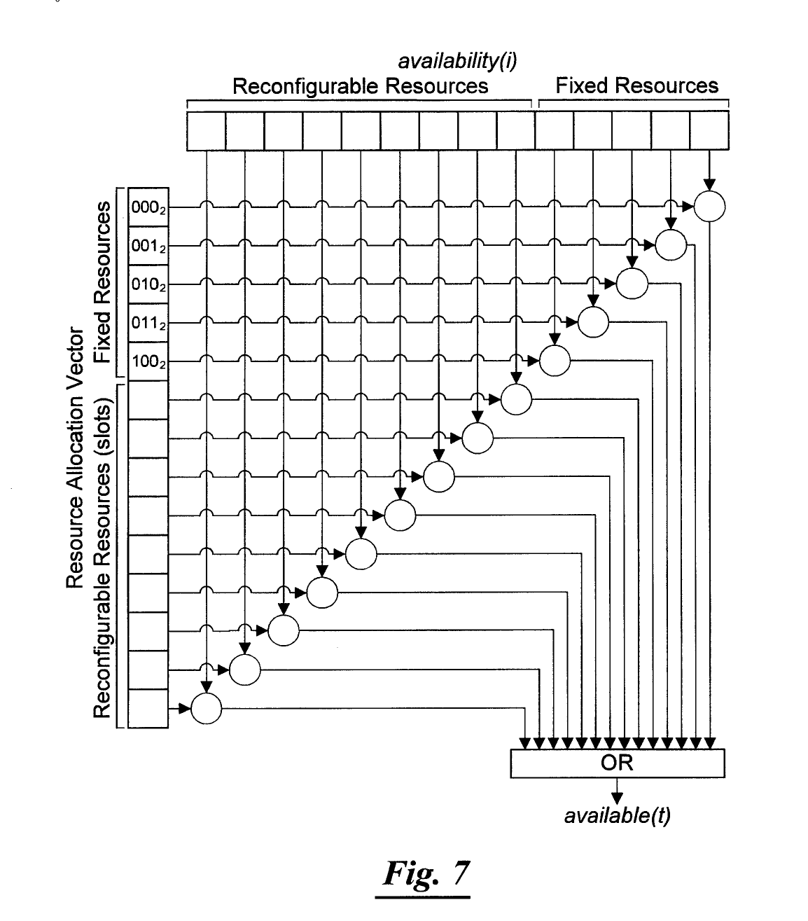

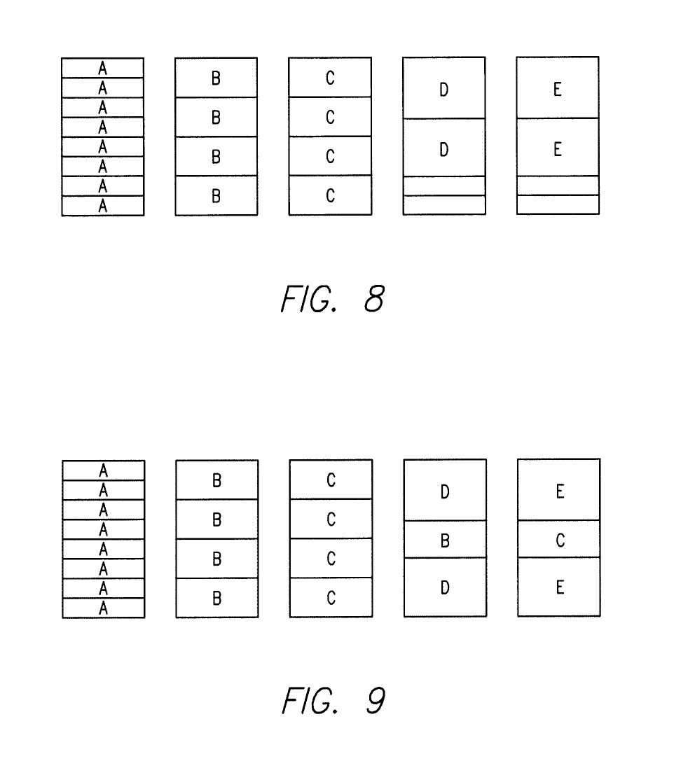

Some functional units require more than one reconfigurable slot. From FIG. 1, we assume that LSUs 12c require one slot, Int units require two slots each, and each type of FP unit requires three slots. If a functional unit spans more than one reconfigurable slot, only one of the entries in the resource allocation vector will contain the encoding of the functional unit and the other entries will contain the encoding 111₂ ensuring that the availability of the functional unit is only considered once in the calculation of the available function. Equation 1 can be realized in hardware using the circuit of FIG. 7.

In FIG. 7, each bit of the resource allocation vector and the corresponding availability signal are applied to the product,

$$( {\prod }_{b ∈ [ 0 , 2 ]} \overline{( {type ( t )}_{b} ⊕ {type ( i )}_{b} )} ) \cdot availability ( i ) ,$$

computed by Equation 1.

An approach to configuration management is introduced for a superscalar reconfigurable architecture having reconfigurable functional units and possibly fixed functional units. The technique proposed matches current requirements with a collection of predefined steering configurations, such as steering vector processing hardware configurations, and the current configuration. By employing partial configuration at the level of functional units, the approach effectively steers the current configuration in the direction specified by the best-matched steering configuration.

Designing the predefined steering configurations to be relatively orthogonal to one another may form the basis necessary to permit a large set of actual configurations that are actually realized, perhaps close to the entire set of possible processor configurations.

The configuration space as described in references [1, 3] is the location in which steering vectors, or parts thereof, are loaded dynamically during runtime. During runtime it is highly probable that one or many RFUs within the configuration space are busy executing instructions, and because of this, RFUs within a steering vector will be partially loaded, thereby forming hybrid combinations of themselves within the configuration space. The complexity of the configuration space is of great interest in that a complete understanding of the configuration space is necessary to design steering vectors for maximum computational performance. If, for example, it were known that a computer spends 99% of its time in one of three different configurations, then it might be a good idea to use those specific three configurations as steering vectors. However, the configurations exhibited by a computer are certainly dependant upon the specific program running; therefore, it is perhaps a better idea to design steering vectors that exhibit a great deal of robustness. In this section two methods for counting the number of unique combinations of RFUs that may be exhibited within a configuration space are explored. The results are then used to formulate a general approach to the design of steering vectors that are capable, through partial reconfiguration, of reaching either all of the possible unique RFU combinations or a subset thereof.

### Counting Unique Combinations

For the static steering vector method of reference [1] it is important to assure that all possible combinations (or all desired combinations) of RFUs are achievable through proper selection of steering vectors. The analysis provided in this section provides results and conditions related to the satisfaction of this objective.

For the purposes of our analysis, we assume a finite reconfigurable space of integer size, and we further assume that the size of the RFU's is of integer measurement and, without loss of generality, that the size of the smallest RFU is unity. For a given collection of steering vectors, there exist a finite number of possible permutations of the RFUs that can ultimately populate the configurable space. Recall that the approach of reference [1] yields a current configuration that is generally a combination of the steering vector components. This is because, at any given time, a particular selected steering vector is typically only partially loaded, i.e., only those vector elements (RFUs) associated with available, non-busy slots are loaded.

Some of the resulting permutations are equivalent in the sense that they contain the same number of RFUs of each type. We will refer to each set of equivalent permutations as a unique combination. The number of unique combinations can be calculated directly from the size of the reconfigurable space and the size of each RFU considered. Let N denote the (integer) size of the reconfigurable space and let E be an n-tuple vector where each element e₁, e₂, e₃, . . . eₙ designates the integer size of n possible RFU types. Finally, let the vector K=<k₁, k₂, k₃, . . . , kₙ> represent the multiplicity of each RFU type present in a given combination. With these definitions, the number of unique combinations is equal to the number of nonnegative integer solutions to Equation (3.1), which is expressed in component form in Equation (3.2). As stated earlier, we assume a minimal RFU size of unity, which implies that all combinations are complete in the sense that “wasted space,” does not exist.

E·K=N (3.1)

k₁e₁+k₂e₂+k₃e₃+ . . . +kₙeₙ=N (3.2)

The number of nonnegative integer solutions to Equation (3.2) may be found either iteratively as in Example 3.1 or with the clever use of a power series representation, as illustrated by Example 3.2.

Example 3.1. Iteratively Determining the number of equivalent subspaces (unique combinations) with E=<1,2,2,3,3> and N=8.

Let k₁, k₂, k₃, k₄, and k₅ be the multiplicity of each execution unit type in a given combination. This leads to the following equation:

k₁+2k₂+2k₃+3k₄+3k₅=8

The number of unique combinations is exactly equal to the number of nonnegative integer solutions to the given equation. Simply, the sum of the sizes of the execution units in a given combination must be equal to eight. From this equation there is certainly an algorithmic method that can be used to determine the number of solutions, but may appear to be awkward since it involves nested loops. For the sake of investigation; an example iteration:

Let: k=k₁

l=k₂+k₃
m=k₄+k₅

Then: k+2l+3m=8

If: m=2

Then: k+2l=2

Notice that m=2 implies k₄+k₅=2, and this can occur 3 different ways:

1. k₄=2 And k₅=0

2. k₄=0 And k₅=2

3. k₄=1 And k₅=1

Notice, there are three ways to fill a space of size six, given that there are only two elements; each with a size of three. The complete iterated solution follows on the next page, beginning just after the l and m substitutions.

Iterating solutions for: k+2l+3m=8

| | | |
|---|---|---|
| If: | m = 2 | 3 solutions |
| Then: | k + 2l = 2 | |
| If: | l = 1 | 2 solutions |
| Then: | k = 0 | |
| If: | l = 0 | 1 solution |
| Then: | k = 2 | |
| If: | m = 1 | 2 solutions |
| Then: | k + 2l = 5 | |
| If: | l = 2 | 3 solutions |
| Then: | k = 1 | |
| If: | l = 1 | 2 solutions |
| Then: | k = 3 | |
| If: | l = 0 | 1 solution |
| Then: | k = 5 | |
| If: | m = 0 | 1 solution |
| Then: | k + 2l = 8 | |
| If: | l = 4 | 5 solutions |
| Then: | k = 0 | |
| If: | l = 3 | 4 solutions |
| Then: | k = 2 | |
| If: | l = 2 | 3 solutions |
| Then: | k = 4 | |
| If: | l = 1 | 2 solutions |
| Then: | k = 6 | |
| If: | l = 0 | 1 solution |
| Then: | k = 8 | |

The number of solutions to the equation is:

3(2+1)+2(3+2+1)+1(5+4+3+2+1)=36

Example 3.2 Calculation of the number of unique combinations with E=<1,2,2,3,3> and N=8.

Recall that k₁, k₂, k₃, k₄, and k₅ are the multiplicity of each RFU type in a given combination. Then from Equation (3.2):

k₁+2k₂+2k₃+3k₄+3k₅=8 (3.3)

The number of unique combinations is exactly equal to the number of nonnegative integer solutions to Equation (3.3). Although an iterative method for determining the solutions is used in Example 3.1, a more convenient way to count the number of solutions is to use a power series representation as shown here in Example 3.2. The identity relation in Equation (3.4) can be used to derive Equation (3.5) references [10].

$$\begin{matrix}{( {\sum }_{i = 0}^{∞} {x}^{i} )}^{2} = {\sum }_{n = 0}^{∞} ( n + 1 ) {x}^{i} If \vert x \vert < 1 & ( 3.4 ) \\ {\sum }_{i = 0}^{∞} ( i + 1 ) {x}^{2 i} = ( 1 + 2 {x}^{2} + 3 {x}^{4} + 4 {x}^{8} + … ) & ( 3.5 )\end{matrix}$$

Consider the exponent, 2i, on the left hand side of Equation (3.5) to represent the amount of available reconfigurable space. Further, for the sake of discussion, assume we wish to fill this space with two different elements, each of size two. Then the coefficient, i+1, represents the number of unique ways that the space can be constructed. A power series representation of our specific example is shown in Equation (3.6). Sᵢ is the number of ways in which we can fill a space of size i using one element of size one, two elements of size two, and two elements of size three. The goal is to find S₈, the coefficient proceeding x⁸ on the left hand side of Equation (3.7).

$${\sum }_{i = 0}^{∞} {S}_{i} {x}^{i} = ( {\sum }_{{k}_{1} = 0}^{∞} {x}^{{k}_{1}} ) ( {\sum }_{{k}_{2} = 0}^{∞} {x}^{2 {k}_{2}} ) ( {\sum }_{{k}_{3} = 0}^{∞} {x}^{2 {k}_{3}} ) ( {\sum }_{{k}_{4} = 0}^{∞} {x}^{3 {k}_{4}} ) ( {\sum }_{{k}_{5} = 0}^{∞} {x}^{3 {k}_{5}} ) \qquad ( 3.6 )$$

Use of Equation (3.4) reduces Equation (3.6) into a compact form given by Equation (3.7), where a=k₁, b=k₂+k₃, and c=k₄+k₅:

$${\sum }_{i = 0}^{∞} {S}_{i} {x}^{i} = ( {\sum }_{a = 0}^{∞} {x}^{a} ) ( {\sum }_{b = 0}^{∞} ( b + 1 ) {x}^{2 b} ) ( {\sum }_{c = 0}^{∞} ( c + 1 ) {x}^{3 c} ) \qquad ( 3.7 )$$

Because there are many ways to obtain an exponent of eight using the exponents on the right hand side of Equation (3.7), we must iterate through them to determine the coefficients whose sum is S₈.

For c=2, an exponent of size six is produced:

$$( {\sum }_{a = 0}^{∞} {x}^{a} ) ( {\sum }_{b = 0}^{∞} ( b + 1 ) {x}^{2 b} ) ( 3 {x}^{6} ) \qquad ( 3.8 )$$

To obtain an exponent of size eight, we can either set b=1 and a=0, or b=0 and

a=2. The results, respectively, are:

(x⁰)(2x²)(3x⁶)=6x⁸ (3.9)

(x²)(x⁰)(3x⁶)=3x⁸ (3.10)

Now, with c=1, an exponent of size three is produced:

$$( {\sum }_{a = 0}^{∞} {x}^{a} ) ( {\sum }_{b = 0}^{∞} ( b + 1 ) {x}^{2 b} ) ( 2 {x}^{3} ) \qquad ( 3.11 )$$

To obtain an exponent of size eight, we can either set b=2 and a=1, or b=1 and a=3, or b=0 and a=5. The results again, respectively:

(x)(3x⁴)(2x³)=6x⁸ (3.12)

(x³)(2x²)(2x³)=4x⁸ (3.13)

(x⁵)(x⁰)(2x³)=2x⁸ (3.14)

With c=0 an exponent of size eight now becomes a full iteration through the variable b. The values are shown here along with the obtained coefficients from the right hand side of Equation (3.7).

$$\begin{matrix}( {\sum }_{a = 0}^{∞} {x}^{a} ) ( {\sum }_{b = 0}^{∞} ( b + 1 ) {x}^{2 b} ) ( {x}^{0} ) \\ For b = 4 , a = 0 \text{:} & ( 3.15 ) \\ ( {x}^{0} ) ( 5 {x}^{8} ) ( {x}^{0} ) = 5 {x}^{8} \\ For b = 3 , a = 2 \text{:} & ( 3.16 ) \\ ( {x}^{2} ) ( 4 {x}^{6} ) ( {x}^{0} ) = 4 {x}^{8} \\ For b = 2 , a = 4 \text{:} & ( 3.17 ) \\ ( {x}^{4} ) ( 3 {x}^{4} ) ( {x}^{0} ) = 3 {x}^{8} \\ For b = 1 , a = 6 \text{:} & ( 3.18 ) \\ ( {x}^{6} ) ( 2 {x}^{2} ) ( {x}^{0} ) = 2 {x}^{8} & ( 3.19 )\end{matrix}$$

Finally, for b=0, a=8:

(x⁸)(x⁰)(x⁰)=x⁸ (3.20)

s₈ is the sum of all the coefficients obtained in the construction of exponents of size eight on the right hand side of Equation (3.7) as shown in Equations (3.9, 3.10, 3.12-3.14, and 3.16-3.20).

S₈=6+3+6+4+2+5+4+3+2+1=36

In this specific example configuration space, thirty-six possible unique execution unit combinations are possible. If desired, it is then possible to select steering vectors that, through partial reconfiguration, will be able to reach all of the possible unique RFU combinations during runtime.

### Steering Vector Design

As stated in previous sections, it is possible to design a set of steering vectors that are capable of forming hybrid RFU combinations during runtime, and if necessary to the needs of the incoming instructions, form each and every possible unique RFU combination. However, it is likely that reaching every possible RFU permutation is not desired and perhaps unnecessary, and instead, it is only necessary to reach a subset of all of the possible RFU combinations. This concept is explored in the next section. In any case, the design of a custom set of steering vectors is an integral part in the success of the steering vector method irrespective of the specific superscalar design instance.

### Determination of Initial Basis Vectors

To develop a set of steering vectors that can reach all of the unique combinations of the RFU types, first observe that within the entire set of unique combinations there exists a subset of combinations in which only one type of RFU appears in each. The size of this subset is equal to the number of RFU types. This set of vectors forms an initial basis for reaching every unique combination. Other valid basis sets can be derived from this subset by interchanging RFUs among the steering vectors, provided that the slots inhabited by a given RFU type remain disjoint from slots inhabited by other RFUs of the same type.

FIG. 8 shows the initial basis vectors for five RFU types <A,B,C,D,E> with corresponding sizes <1,2,2,3,3> and a configuration space size of eight. From Examples 3.1 and 3.2 it is known that through partial reconfiguration that these initial basis vectors can exhibit at most 36 unique RFU combinations.

### Generating Basis Sets

Examination of FIG. 8 reveals that careful interchanging of RFU types among the initial basis vectors will result in other valid basis sets. A more appropriate description of the desired property, i.e., reaching all of the possible unique combinations, is that of a cover.

A cover y is a family of non-empty subsets of X whose union contains the set X, and a minimal cover is a cover for which removal of one member destroys the covering property. See reference [11] for example. In the case of steering vectors where RFU type, size, and location are all equally important properties, it is useful to view each steering vector as a set of points in [symbol] . Each set representing either a steering vector, or combination thereof, can be modeled as a set of points governed by the properties that:

(1) No points within the set describe RFUs occupying disjoint space within a configuration and

(2) The summation of the sizes of all RFUs within any set is fixed.

Also, since the configuration space size may not be divisible by all of the specific RFU sizes, it is necessary to include an extra empty RFU type.

The cover described by the initial basis vectors shown in FIG. 8 is described below in Example 3.3. In general, any minimal cover for a set of initial basis vectors, where initial basis vectors are the subset of all unique combinations in which only one RFU type appears in each, is a valid basis set.

Example 0.1. Describing a Cover for A Steering Vector Configuration Space.

Let each RFU be represented by a point in [symbol] of the form (type, location, size), where typeε[A, B, C, D, E, Empty], locationε[0,1,2,3,4,5,6,7], and sizeε[1,2,3]. Also, each set is subject to a fixed size of 8. The minimal cover for the set of initial basis vectors shown in FIG. 8 is shown here in Equation (3.21).

$$\{ \begin{matrix}\{ \begin{matrix}( A , 0 , 1 ) , ( A , 1 , 1 ) , ( A , 2 , 1 ) , ( A , 3 , 1 ) , \\ ( A , 4 , 1 ) , ( A , 5 , 1 ) , ( A , 6 , 1 ) , ( A , 7 , 1 )\end{matrix} \} , \\ \{ ( B , 0 , 2 ) , ( B , 2 , 2 ) , ( B , 4 , 2 ) , ( B , 6 , 2 ) \} , \\ \{ ( C , 0 , 2 ) , ( C , 2 , 2 ) , ( C , 4 , 2 ) , ( C , 6 , 2 ) \} , \\ \{ ( D , 0 , 3 ) , ( D , 3 , 3 ) , ( Empty , 6 , 2 ) \} , \\ \{ ( E , 0 , 3 ) , ( E , 3 , 3 ) , ( Empty , 6 , 2 ) \}\end{matrix} \} \qquad ( 3.21 )$$

### The Design and Advantage of Spanning Sets

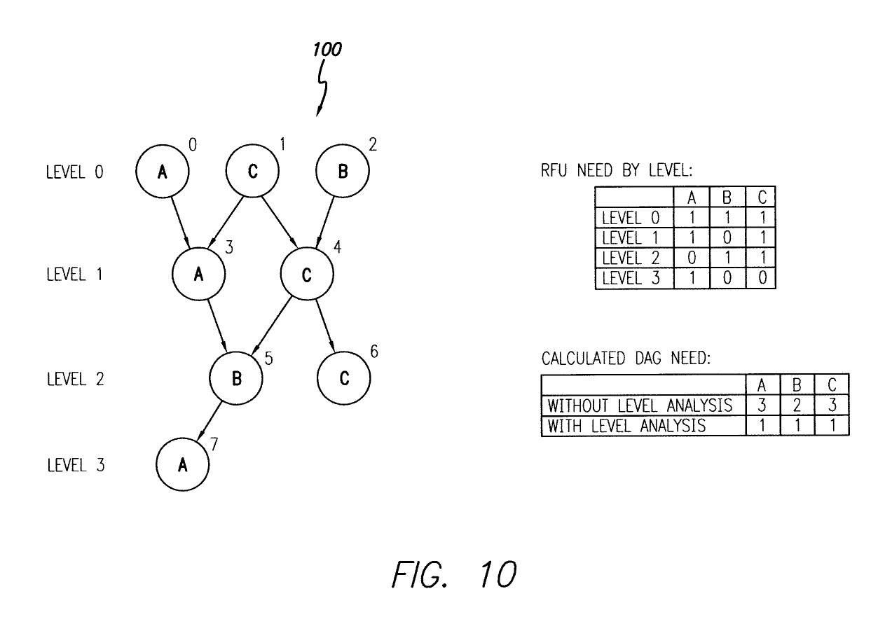

The design of a set of basis steering vectors that do not have empty space is not always possible, and the empty space can be used to increase the flexibility of the steering vectors. However, transforming a basis set into a spanning set is only useful if the empty space can be used to add RFUs that do not occupy the exact contiguous space occupied by RFUs of the same type. Since steering vector design begins with a set of basis vectors, any additional RFUs added should overlap with those of the same type, thereby allowing the steering vectors to reach a larger number of permutations during runtime. It is advantageous for the steering vectors to reach as many permutations as possible because space may be available during runtime but not necessarily in the locations in which RFUs appear within the vectors. Therefore, it is best to be able to load RFUs in as many locations as possible because the effects of fragmentation during runtime are not easily determined for a general computing program. The challenge addressed by the design of a spanning set of steering vectors is that while it will be possible to reach every unique combination with a basis set, the fragmentation of available slots in the configuration space may create situations in which it is desirable to reach other permutations of RFUs. An example of the proper use of empty space is shown in FIG. 9.

### Loading Strategy Overview

Loading strategy refers to the specific scheme used to determine which RFUs are to be loaded and the location they are to be loaded into. The steering vectors method uses steering vectors to pre-define the possible positions that RFUs may be loaded into, and a scoring technique is employed to select the steering vector that best matches the current need of the incoming instructions. Steering vectors are scored based upon a table of incoming instructions, and perhaps also the specific instruction dependency information. In reference [1] the four-stage configuration selection unit 42, shown previously in FIG. 2 and continued in FIGS. 3(a), 3(b) and 3(c), is used to generate an error metric that compares the needs of the instructions to the resources of each steering vector and to the current configuration. The error metric generation circuit 46 scores all of the instructions in the instruction buffer 22 including instructions that have already been issued to either FFUs 12 or RFUs 14. It is obvious that scoring all instructions in the instruction buffer 22, regardless of their status, may not provide the best measurement of the executing program's future need, and therefore it was beneficial to design a simulator capable of evaluating the performance of several alternative scoring methods that are discussed further in the next section.

### Analysis of Steering Vector Selection Techniques

There are several obvious ways to score the steering vectors:

(1) Score all instructions in the table

(2) Score only instructions ready for execution

(3) Score only dependent instructions and

(4) Score only instructions that are not executing.

There are several drawbacks that are common to all of these scoring methods such as:

(1) Steering vectors are selected because of specific RFUs 14 that they contain, but this does not imply that the desired units can be loaded at the desired time.

(2) If multiple instructions that require the same RFU 14 are dependent upon one another, then they only require one RFU 14, and these scoring methods fail to identify reusability of RFUs 14.

The problem with these scoring methods is that reconfigurable units 14 will be loaded that cannot be used, and reconfigurable units 14 that can be used in the future will be discarded. In effect, the four steering vector scoring methods are unable to fully exploit all of the ILP, and the development of an improved scoring method appears desirable.

### Dynamic Steering Vector Method

### Dependency Analysis

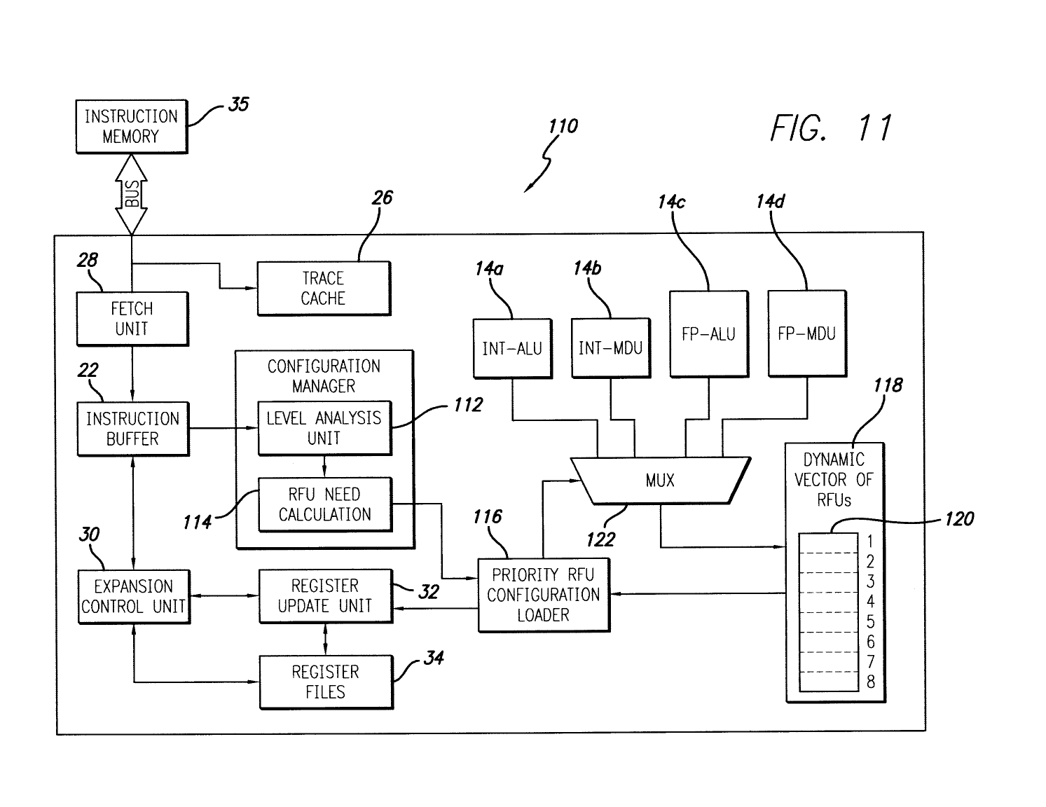

In order to determine the specific type and quantity of RFUs 14 necessary to fully exploit all instruction level parallelism (ILP) within a specific directed acyclic graph (DAG), both dependency analysis and instruction need calculations must be performed in unison. FIG. 10 shows an example DAG 100 with corresponding RFU 14 need calculated both with and without dependency level consideration. The results show that calculation by dependency level results in a greatly reduced RFU 14 need. Calculation of the RFU 14 need by dependency level will always result in reduced RFU 14 need whenever at least two instructions residing in different levels of the DAG 100 require the same resource (RFU) type. The next section describes a level analysis procedure that examines the DAG 100 and produces a priority-based list of resources necessary for both executing the instructions in the DAG 100 and simultaneously exploiting all ILP within the DAG 100. In combination with the dynamic vector update procedure ILP is maximized while reconfiguration is minimized.

### Level Analysis Procedure

The dependencies between instructions in the instruction buffer 22 can be represented by a dependency matrix D. Note that D is of square dimension and is of size n×n, where n is equal to the number of instructions. Any element of D, dᵢⱼ, having a logic value of one indicates that instruction i is dependent upon the completion of instruction j; otherwise, dᵢⱼ has a logic value of zero. A procedure is presented that transforms the instruction dependency matrix D into a level readiness matrix T, where any element, tᵢⱼ, having a logic value of one indicates that instruction j is a member of level i. For convenience in transforming matrix D into matrix T, an intermediate matrix M is used, where each element in M, mᵢⱼ, having a logic value of one indicates that instruction j is a member of level less than or equal to i.

Observe that any instructions that depend solely on those that are members of level zero must be members of level one and additionally, all instructions in level one must be dependent upon at least one instruction that is a member of level zero. Thus, it is apparent that if the projection of row i of D onto row j of M is equal to row i of D, instruction i must depend on a level less than or equal to j. Following this logic, matrix M is created, as specified in Equation (4.1). Also, in Equation 4.1, k is used as a temporary columnar index.

$${m}_{i , j} = \{ \begin{matrix}\overline{{\sum }_{k = 0}^{n - 1} {d}_{i , k}} & if i = 0 \\ \overline{{\sum }_{k = 0}^{n - 1} \{ ( {m}_{i - 1 , k} \cdot {d}_{j , k} ) ⊕ {d}_{j , k} \}} & if 0 < i < n\end{matrix} \qquad ( 4.1 )$$

Note that M defined by Equation (4.1) is complete, and each entry indicates that instruction i is dependent upon at least level j. The next step will be to separate the rows of M to further segregate the instructions such that an entry in matrix T will indicate that instruction i is a member of level j. The final step in the transformation from D→T is shown in Equation (4.2). This equation applies an XOR operation across the columns of M to separate the rows of M.

$${t}_{i , j} = \{ \begin{matrix}{m}_{i , j} & if i = 0 \\ {m}_{i , j} ⊕ {m}_{i - 1 , j} & if 0 < i < n\end{matrix} \qquad ( 4.2 )$$

The intermediate matrix, M, is not necessary for implementation, and T can be computed directly from D using a combinational circuit. Example 4.1 shows the DVC level analysis procedure for the DAG 100 shown in FIG. 10, where an instruction buffer 22 of size eight is assumed.

Example 4.1. Calculating matrix, T, from matrix, D, begins with a complete dependency matrix D, obtained, in this example, by analyzing FIG. 10.

$$D = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 1 & 1 & 0 & 0 & 0 & 0 & 0 & 0 \\ 0 & 1 & 1 & 0 & 0 & 0 & 0 & 0 \\ 0 & 0 & 0 & 1 & 1 & 0 & 0 & 0 \\ 0 & 0 & 0 & 0 & 1 & 0 & 0 & 0 \\ 0 & 0 & 0 & 0 & 0 & 1 & 0 & 0\end{matrix} ]$$

The first row of matrix M is calculated using Equation (4.1), where i=0. Elements m_{0,0} and m_{0,5} are shown in Equations (4.3 and 4.4), respectively. Equation (4.5) shows row zero of M.

$$\begin{matrix}{m}_{0 , 0} = \overline{{\sum }_{k = 0}^{7} {d}_{0 , k}} = 1 & ( 4.3 ) \\ {m}_{0 , 5} = \overline{{\sum }_{k = 0}^{7} {d}_{5 , k}} = 0 & ( 4.4 ) \\ {M}_{row ( 0 )} = [ \begin{matrix}1 & 1 & 1 & 0 & 0 & 0 & 0 & 0 ]\end{matrix} & ( 4.5 )\end{matrix}$$

The result obtained in Equation (4.3) shows that instruction zero is a member of level zero. Equation (4.4) shows that instruction number 5 is not a member of level zero. All other rows of M are calculated using the second part of Equation (4.1). Equations (4.6-4.8) show the calculation of m_{1,4}.

$$\begin{matrix} {m}_{1 , 4} = {\sum }_{k = 0}^{7} \{ ( {m}_{0 , k} \cdot {d}_{4 , k} ) ⊕ {d}_{4 , k} \} & ( 4.6 ) \\ {m}_{1 , 4} = \{ [ \begin{matrix}1 & 1 & 1 & 0 & 0 & 0 & 0 & 0 ]\end{matrix} \cdot [ \begin{matrix}0 & 1 & 1 & 0 & 0 & 0 & 0 & 0 ]\end{matrix} \} ⊕ [ \begin{matrix}0 & 1 & 1 & 0 & 0 & 0 & 0 & 0 ]\end{matrix} \\ & ( 4.7 ) \\ {m}_{1 , 4} = 1 & ( 4.8 )\end{matrix}$$

Calculating each element, shown in Equations (4.6-4.8) results in M, shown in Equation (4.9):

$$M = [ \begin{matrix}1 & 1 & 1 & 0 & 0 & 0 & 0 & 0 \\ 1 & 1 & 1 & 1 & 1 & 0 & 0 & 0 \\ 1 & 1 & 1 & 1 & 1 & 1 & 1 & 0 \\ 1 & 1 & 1 & 1 & 1 & 1 & 1 & 1 \\ 1 & 1 & 1 & 1 & 1 & 1 & 1 & 1 \\ 1 & 1 & 1 & 1 & 1 & 1 & 1 & 1 \\ 1 & 1 & 1 & 1 & 1 & 1 & 1 & 1 \\ 1 & 1 & 1 & 1 & 1 & 1 & 1 & 1\end{matrix} ] \qquad ( 4.9 )$$

Matrix, T, is determined using Equation (4.2). Calculation of t_{1,3} and t_{1,6} are shown in Equations (4.10) and (4.11), respectively.

t_{1,3}=m_{1,3}⊕m_{0,3}=1 (4.10)

t_{1,6}=m_{1,6}⊕m_{0,6}=0 (4.11)

The result shown in Equation (4.10) indicates that instruction number three is a member of level one. The result shown in Equation (4.11) indicates that instruction number six is not a member of level one. Examination of FIG. 10 confirms the results obtained in Equations (4.10) an (4.11), as well as the final matrix, T, shown below in Equation (4.12).

$$T = [ \begin{matrix}1 & 1 & 1 & 0 & 0 & 0 & 0 & 0 \\ 0 & 0 & 0 & 1 & 1 & 0 & 0 & 0 \\ 0 & 0 & 0 & 0 & 0 & 1 & 1 & 0 \\ 0 & 0 & 0 & 0 & 0 & 0 & 0 & 1 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] \qquad ( 4.12 )$$

### Dynamic Vector Update Procedure Overview

Given the results obtained through level analysis of the DAG 100 and information on the specific resource requirements of any given instruction, the exact resources necessary for exploiting all of the ILP for any given sub-DAG can be determined. A priority-based scheduling solution exists provided that the allocated resource space is at least as large as the largest RFU 14. We assume that RFU slots can be reconfigured as necessary if contiguous available space exists that is greater than or equal to the size of the RFU 14 being configured. The goals of the dynamic vector update (DVU) procedure are to

(1) Avoid loading unnecessary resources,

(2) Avoid discarding valuable resources, and

(3) Guarantee efficient execution of instructions along the critical path when possible.

### Dynamic Vector Method Architecture

Referring now to FIG. 11, shown therein and designated with a reference numeral 110 is a dynamic vector method architecture constructed in accordance with the present invention. The dynamic vector method architecture 110 is very similar to the steering vector architecture depicted in FIG. 1 and discussed previously, except as discussed below. Major changes to the architecture are made in two areas:

The configuration selection and loading units 42 and 70 of FIG. 1 are replaced with a level analysis unit 112 and a RFU need calculation unit 114, and a priority configuration loader 116 is inserted that allows the machine to select multiple independent RFUs 14 (designated by way of example as 14a, 14b, 14c and 14d) and load the independent RFUs 14 into any available location of a dynamic vector 118 having a plurality of reconfigurable slots 120 (8 reconfigurable slots 120 are depicted in FIG. 11 by way of example) of RFUs, thereby eliminating the need for steering vectors.

In a preferred embodiment, the level analysis unit 112 can be implemented in combinational logic. Extending the level analysis design to include the RFU need calculation circuit 114 does not require much more logic, and most likely can be realized by a combinational circuit. In addition, it is possible to simplify the level analysis procedure for an implementation that would greatly reduce the amount of required logic. A simplified implementation of the level analysis procedure could examine instructions that are ready for execution (dependencies satisfied), identified by a wired or circuit, and then perform a summation to determine the number of instructions that depend on each “ready” instruction. The result of calculating the number of instructions that depend on “ready” instructions would provide a measurement of the potential ILP obstructed by the specific “ready” instruction.

Implementation of the priority RFU configuration loader 116 will require information regarding the “by-level” RFU need as well as information regarding the current configuration of the dynamic vector 118. The by-level need should be in the form of a vector that contains the necessary number of RFUs by type. Each possible level should have one vector that contains the RFU counters. Also, the priority RFU configuration loader 116 will require a vector that describes which RFU slots 120 are available. The RFU priority loader 116 can then attempt to load RFUs required for level 0 and also update the temporary status of the RFU slots, then iterate through the levels of RFU need vectors until no available space of required size exists.

A temporary vector should be used at each RFU loading level that is updated and then passed as an output to the next loading level, such that a combinational priority RFU configuration loader is possible.

The unique factor associated with the dynamic vector 118 is that multiple copies of RFU memory descriptions are not necessary, and a multiplexer 122 (or other device(s), such as busses based on tri-state buffers) can be used to multiplex RFUs 14 to the various RFU configuration slots 120, provided that the logic required for the huge number of multiplexers is less than the logic required to store the necessary number of RFU memory descriptions.

### Dynamic Vector Update Procedure Details

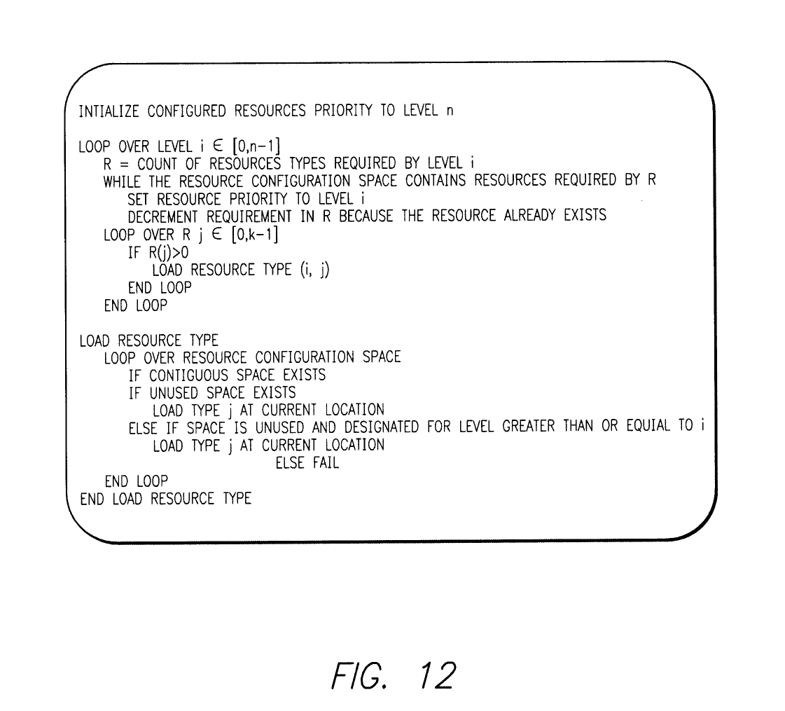

Let R be a k element vector where each element is of size ┌log₂ n┐, and each element, rⱼ, represents the number of resources of type j necessary for satisfying instructions at the level currently being analyzed. Using R, an exemplary Dynamic Vector Update (DVU) procedure is shown in FIG. 12 and which is preferably executed by the RFU need calculation unit 114 depicted in FIG. 11. In a preferred embodiment, the Dynamic Vector Update procedure would be implemented in hardware as a combinational, possibly pipelined, circuit. Note that only unassigned instructions are considered to have RFU needs, and the DVU procedure only analyzes unassigned instructions.

To avoid loading of unnecessary resources, examination of resource needs by level guarantees that the possibility of reusing resources between levels is completely exploited. For example, if level zero requires two type A resources, and level three requires one type A resource, and no other levels require any type A resources, then the actual need for all levels is two type A resources. In contrast, the steering vector approach would assume that three type A resources are necessary, the level dependency analysis procedure makes efficient use of resources, and that this analysis can detect that multiple levels can utilize the same resources over time.

To avoid discarding valuable resources, if there are unused RFU slots 120, the dynamic loading strategy will use those slots 120. Over time it becomes necessary to discard unused resources and load others. For example, if level one requires RFU type B and the RFU is not currently loaded into any slot, the procedure would allow a resource of type B to be loaded in any space that will not be used for levels zero or one. To guarantee that valuable resources are not discarded, any level being analyzed for resource loading can only discard resources that are not designated for use by a previous level, including the current level. This policy also has the effect of making the process of resource discarding priority-based. The exploitation of ILP at level zero is limited by the size of the configuration space and the ability to locate contiguous available space for loading the required RFUs. Therefore, the instruction buffer 22 and the configuration space should be carefully designed to ensure that the DVU procedure is able to utilize ILP.

### Conclusions and Recommendations

The conclusions drawn from studying the configuration space with respect to steering vector design indicate that steering vectors of RFUs can be mathematically designed to have properties of a basis or spanning set. The specific scoring methods tested in simulation (and described in detail in the provisional patent application identified by U.S. Ser. No. 60/923,461 which is hereby incorporated herein by reference) reveal a great deal about how the processor works, and perhaps how little ILP is actually available in the Susan benchmark. Also, the design and simulation of the dynamic vector method indicate that a large enough number of configuration slots will allow the processor to converge to many stable RFU configurations during the course of a program's execution.

A partial understanding of the configuration space, specifically for the steering vectors method, allows for the intelligent design of steering vectors that span all of the possible unique RFU combinations, and at the same time span many permutations of the unique RFU combinations as well. At this time it is not completely clear whether the spanning set of steering vectors provide improved performance over those that do not span the unique RFU combinations. It is recommended that the design of steering vectors be studied in the future through simulation of other benchmarks and with several other sets of predefined steering vectors.

The steering vector simulation results indicate that the steering vector scoring method has little effect on the overall execution time of the processor, but does dictate the method employed by the processor in maintaining equivalent execution times. The range of total execution times for the four steering vector scoring methods is very similar, but the FFU 12 and RFU 14 usage increase and decrease to compensate for one another, resulting in similar total execution time regardless of scoring method. Future study in the area of steering vector scoring methods should focus mainly on simulating the four scoring methods with several other benchmarks. The four steering vector scoring methods cover the simple instruction scoring methods, and it is recommended that, perhaps, with an integer linear programming solution, the instructions may be scored by dependency level and then used to select an appropriate steering vector.

The dynamic vector method simulation results indicate that an increase in the number of configuration slots 120 will result in improved configuration stability. The dynamic vector RFU configuration converges to a stable configuration at the time when the RFUs 14 required to exploit all ILP are present.

It is likely, through the course of a program, that there will be many stable RFU configurations that are transitioned across based on the changing RFUs necessary to exploit the given ILP. It is recommended that the dynamic vector be simulated with other benchmarks as well, and that further attempts be made to identify the stable configurations that occur during runtime. If a study is conducted that identifies several stable configurations, then perhaps these configurations could be used as larger sized steering vectors. Thus, in essence, the static steering vectors represent predefined combinations of execution units wherein only those combinations can be reached. The dynamic vector method as discussed herein, provides many more reachable permutations, but at the expense of having to rely on a typically more complex selection procedure such as that shown in FIG. 12 for example.

It is further recommended that future development of the steering vector method begin first with further simulations focusing on many other benchmark evaluations, and secondly with larger numbers of configuration slots. It is believed that simulations with other benchmarks that provide a larger amount of ILP will provide an opportunity for the steering vector RFUs to be better utilized, thereby enhancing performance of the steering vector method and validating the concept as a whole. It is also likely that either increasing or decreasing the size of the steering vectors as well as the size of the configuration space may lead to an increase in the performance of the steering vector method. In addition, it is certainly clear, from dynamic vector simulation, that scoring instructions by dependency level results in better ILP detection, and with a well matched and responsive RFU loading strategy, will most likely lead to improved ILP exploitation for the steering vector method as well. Lastly, if validated in the simulation process, the steering vector method could be implemented in hardware, but it is extremely important that simulations be used first to determine the parameters that maximize RFU usage.

For the dynamic vector method, future work should first focus on simulating alternative benchmarks, and secondly on implementing a dynamic vector control unit in high performance hardware. There are not very many parameters associated with the dynamic vector, and the best configuration space size can be determined with a hardware implementation just as easily as it can with a simulation. However, owing to the amount of logic required to implement the level analysis procedure, it is likely that the dynamic vector study can benefit from further simulations with the four steering vector scoring methods as well.

Essentially, both the steering vector method and the dynamic vector method can benefit first from an exhaustive simulation repertoire, which should be used to further compare the two competing methods, and then to determine the set of parameters that both maximize the exploitation of ILP and minimize the required hardware. For example, it is known that the four steering vector scoring procedures require much less logic than the level analysis and RFU need calculations of the dynamic vector method. However, the behavior of the scoring methods when interchanged between the dynamic vector method and the steering vector method is not yet known. It is believed that further simulations aimed at reducing hardware size and maximizing performance will lead to perhaps a hybrid steering vector and dynamic vector architecture that is better suited to implementation. Perhaps, and this is only speculation, the use of mini steering vectors, where each vector is comprised of one, two, or three RFUs 14 in combination with the dynamic vector method could result in a very interesting hybrid architecture. Also, the mini vectors, or for that matter the RFUs 14 of the dynamic vector, may not be loadable into any configuration slot 120, but rather, they may load into a range of configuration slots 120.

### Design of Steering Vectors for Dynamically Reconfigurable Architectures

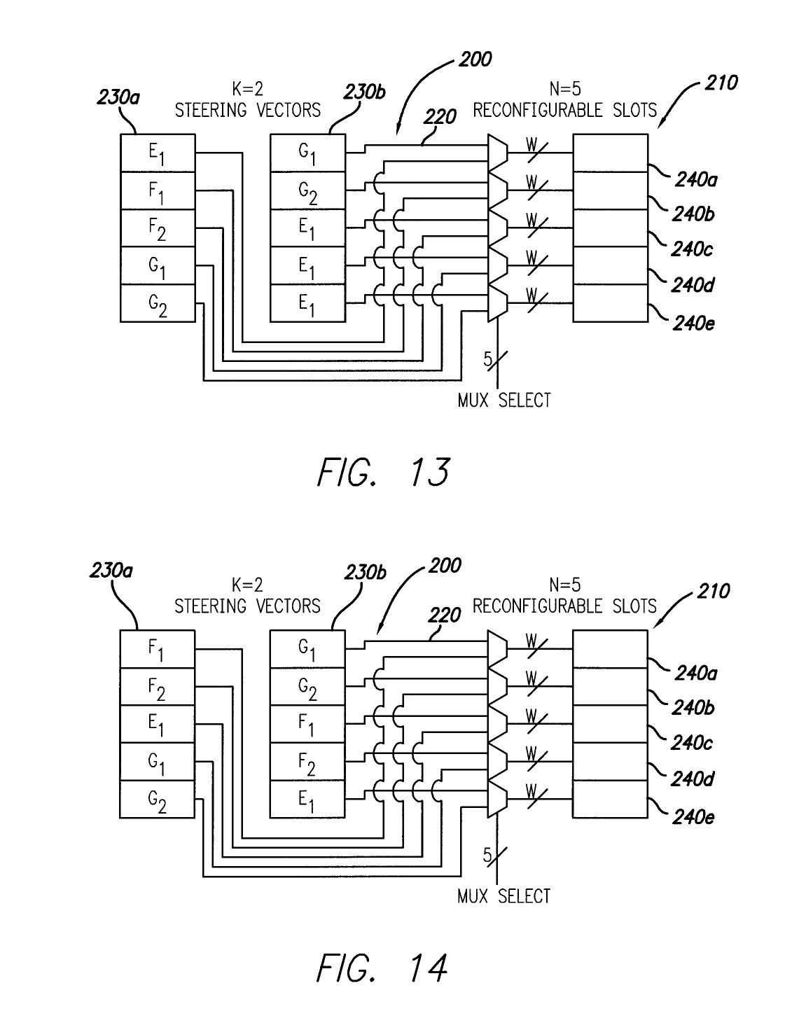

FIG. 13 illustrates a reconfigurable framework 200 of a portion of the reconfigurable processor 10 depicted in FIG. 1 that can support dynamic reconfiguration. The framework has three main components: reconfigurable resources 210 (that are similar to the RFUs 14); an interconnection network 220; and steering vectors 230 (only two being shown by way of example and designated as 230a and 230b).

The reconfigurable resources 210 are partitioned into N slots 240 (five slots being shown and designated by reference numerals 240a-e by way of example). As shown in FIG. 13 for N=5 Configuration bits are used to define the configuration of each reconfigurable slot 240, and these bits are stored in memory (or a configuration storage, e.g., hard disk drive, read only memory, random access memory, flash memory, or the like.) that defines the steering vectors 230. Each slot 240 can be reconfigured independently from the other slots 240. Thus, it is possible for one or more slots 240 to be loading new configuration bits (i.e., reconfiguring) while other slots 240 are performing computations. Furthermore, adjacent slots 240 can be ganged together to form a functional unit that spans multiple slots 240.

The interconnection network 220 has a number of data paths that is referred to herein as the width “W”. As illustrated in FIG. 13, the width “W” defines the number of configuration bits that are loaded in parallel on each bus cycle. Thus, at one extreme, W=1 represents the case where the hardware only supports configuration bits being loaded in a bit-serial fashion. At the other extreme, W could be on the order of thousands or even hundreds of thousands, which would drastically reduce the time required to load configuration bits into the reconfigurable slots. For dynamic reconfiguration to be practical and useful, the value of W must be sufficiently large so that the delay associated with loading configuration bits can be tolerated. The fundamental issue is that the time required to reconfigure must be more than compensated for by the advantage, in terms of performance, in electing to perform the reconfiguration.

The interconnection network 220 (including the MUXs in FIG. 13) provides switching action from configuration bits (stored in the steering vectors) to the reconfigurable resources. For the study here, the interconnection network 220 is assumed to be comprised of N independently controllable busses; however, in principle, more sophisticated interconnection schemes can be assumed for this component of the framework. Each bus assumed here can be independently controlled to select from among K configurations. As mentioned above, constructing wider buses has the advantage of decreasing reconfiguration time, but the disadvantage of requiring more hardware to implement. The value of K impacts the number of overall configurations that can be reached by the reconfigurable resources: larger values of K generally afford a larger number of configurations to be reached. However, larger values of K translate, again, into more hardware to implement the busses.

The input values associated with each of the N busses in FIG. 13 are the configuration bits stored in memory, and are defined to be corresponding elements of K steering vectors 230. Each of the N elements of the steering vector 230 stores the configuration bits associated with a functional unit, or a portion of a functional unit. In the example shown, there are configuration bits stored in the steering vectors 230 that represent configurations for three functional units, denoted by E, F, and G. The configuration bits for unit E fit into one slot, and are denoted by E₁. Units F and G each require two slots; thus, their configuration bits require storage that spans two adjacent elements of the steering vector 230, denoted by elements F₁,F₂ and G₁,G₂, respectively.

Two obvious examples of configurations that can be reached by the steering vectors of FIG. 13 are the two steering vectors themselves, i.e., (E₁,F₁,F₂,G₁,G₂)^{T} and (G₁,G₂,E₁,E₁,E₁)^{T}. Furthermore, because the N=5 busses are independently controlled, it is possible to reach a configuration that is a combination of the two steering vectors, such as (G₁,G₂,E₁,G₁,G₂)^{T}. Thus, the architectural framework enables the reconfigurable slots to be loaded with a mixture of elements from the steering vectors 230. In general, there are a total of N log₂ K select lines that are available for controlling the selection lines of the MUXs. For the case shown in FIG. 13 with N=5 and K=2, there are five selection lines.

Based on the steering vectors 230 defined in FIG. 13, observe that it is not possible to reach a configuration in which there are two copies of unit F, and one copy of unit E loaded into the reconfigurable resources. However, if the steering vectors 230 defined in FIG. 14 were to be employed instead, then this configuration is indeed reachable. The question addressed below is how to design the steering vectors so that desired configurations of the reconfigurable resources can be reached.

An important objective considered in this study is to utilize a value of K (i.e., number of steering vectors) that is as small as possible, because large values of K require greater hardware complexity to implement. This complexity manifests itself as logic complexity required to implement the K×1 busses. Note that the configuration bits for each unit of the steering vectors 230 only need to be stored once, and fanned out to the appropriate MUXs. The configuration bits for each unit of the steering vectors 230 are shown repeatedly for purposes of clarity. The overarching theme, therefore, is to design K steering vectors, with K being as small as possible, to allow the system to reach those configurations that are known to be desirable. For example, it is a waste of hardware complexity to implement a system that supports four steering vectors 230, if two steering vectors 230 exist that enable the architecture to reach all desirable configurations. In such a case, the complexity saved by decreasing K from four to two could be re-applied to increase the bus width, W, and thereby decrease reconfiguration time.

### Steering Vector Design

Up until this point, only architectural examples in which the steering vectors 230 were already defined have been considered, e.g., referring to FIGS. 13 and 14. This section addresses how to determine, in a systematic way, the best choices for the number and composition of steering vectors 230.

### Mathematical Notation

To precisely formulate the steering vector design problem, mathematical notation is introduced. Denote the K steering vectors 230 as s₁, . . . , s_{K}, where each steering vector 230 is of size N slots and each slot represents a distinct portion of a functional unit. The i^{th} element of a steering vector 230 stores configuration bits that are used (when selected) to configure the i^{th} slot of the reconfigurable resources.

To model the control of selection for the busses, define K control vectors c₁, . . . , c_{K}, where each control vector is of length N. A valid collection of K control vectors must satisfy the following two conditions:
(1) The elements of the control vectors can only be zero or one, i.e., cᵢε{0,1}^{N}, for all iε{1, 2, . . . , K}.
(2) The sum of all K control vectors equals a vector having all elements equal to unity.

For a given collection of control vectors, the configuration that is loaded into the reconfigurable resources is denoted by the vector l, where

$$l = {\sum }_{i = 1}^{K} {c}_{i} ∘ {s}_{1} \qquad ( 5.1 )$$

and the “∘” operator denotes Hadamard (entrywise) product of two vectors. To illustrate the notation, the K=2 steering vectors 230 in FIG. 14 are defined by s₁ and s₂ as:

$${s}_{1} = ( \begin{matrix}{F}_{1} \\ {F}_{2} \\ {E}_{1} \\ {G}_{1} \\ {G}_{2}\end{matrix} ) and {s}_{2} = ( \begin{matrix}{G}_{1} \\ {G}_{2} \\ {F}_{1} \\ {F}_{2} \\ {E}_{1}\end{matrix} ) \qquad ( 5.2 )$$

An example of two valid control vectors are:

$${c}_{1} = ( \begin{matrix}1 \\ 1 \\ 0 \\ 0 \\ 0\end{matrix} ) and {c}_{2} = ( \begin{matrix}0 \\ 0 \\ 1 \\ 1 \\ 1\end{matrix} ) \qquad ( 5.3 )$$

Thus, the overall configuration that would be loaded into the reconfigurable resources is given by:

$$l = ( \begin{matrix}1 \\ 1 \\ 0 \\ 0 \\ 0\end{matrix} ) • ( \begin{matrix}{F}_{1} \\ {F}_{2} \\ {E}_{1} \\ {G}_{1} \\ {G}_{2}\end{matrix} ) + ( \begin{matrix}0 \\ 0 \\ 1 \\ 1 \\ 1\end{matrix} ) • ( \begin{matrix}{G}_{1} \\ {G}_{2} \\ {F}_{1} \\ {F}_{2} \\ {E}_{1}\end{matrix} ) = ( \begin{matrix}{F}_{1} \\ {F}_{2} \\ {F}_{1} \\ {F}_{2} \\ {E}_{1}\end{matrix} ) \qquad ( 5.4 )$$

Two configurations of the reconfigurable resources are defined to be equivalent if each configuration contains the same number of each type of functional unit. For example, the configuration (E₁,E₁,G₁,G₂,E₁)^{T} is equivalent to the configuration (G₁,G₂,E₁,E₁,E₁)^{T}. Thus, if one configuration is a permutation of another, they are said to be equivalent and are members of the same equivalence class. As another example, the two steering vectors 230 defined in FIG. 14 belong to the same equivalence class.

### Design Methodology

For this study, assume that the number of slots, N, and the number and size of each type of functional unit are given. In reference [2], a methodology was developed for enumerating all equivalence classes of configurations of reconfigurable resources (given the number of slots and the number and size of each type of functional unit).

It is important to note that the methodology of reference [2] does not specify the number and composition of steering vectors 230, rather, it defines all possible configurations based on the given number of slots and the number and sizes of the functional units. In reference [2], an example calculation is performed for the case of N=8 and five functional units in which the first functional unit is of size one, the second is of size two, the third is of size two, the fourth is of size three, and the fifth is of size three. For that particular example, it is shown in reference [2] that all possible configurations are represented by only 36 equivalence classes. Note that, many of the equivalence classes contain a relatively large number of permutations.

The present approach first requires the designer to specify a collection of configurations that are deemed most important (i.e., should be reachable). For the case described in the previous paragraph, the designer specifies which of the 36 equivalence classes must be reachable. Suppose, for the sake of discussion, that the designer specifies that only twelve of the 36 possible equivalence classes need to be reachable. A secondary specification from the designer is the degree of importance of each of the configurations that need to be reachable. Given this input from the designer, the objective of our approach is to aid the designer in specifying a minimal set of steering vectors (two is better than four) that satisfy the designer's requirements.

To formalize the approach thus far; given that the number of slots N is specified and that the number and size of each functional unit is specified, the first step is to determine the associated equivalence classes for all possible configurations. Denote the number of equivalence classes by Q, and denote representatives from each of these equivalence classes with the vectors V₁, . . . , V_{Q}. Let [Vᵢ] represent the equivalence class associated with Vᵢ, and |[Vᵢ]| represent the number of members (i.e., permutations) in [Vᵢ]. Define U as the universe of all possible permutations, which is the union of all equivalence classes:

$$U = {⋃}_{i ∈ \{ 1 , … , Q \}} [ {V}_{i} ] \qquad ( 5.5 )$$

Consider a collection of K steering vectors 230 chosen from the universe U. Let L denote the number of possible ways to select K steering vectors 230 from the universe U, thus

$$L = \frac{\vert U \vert !}{( \vert U \vert - K ) ! K !} . \qquad ( 5.6 )$$

Let Sᵢ⊂U denote the i^{th} collection of K steering vectors selected from the universe, where iε{1, 2, . . . , L}. Construct an L×Q matrix M, where each column in the matrix is associated with an equivalence class and each row is associated with a set of steering vectors 230. The value of matrix element mᵢⱼ denotes the number of members (i.e., permutations) of equivalence class [Vⱼ] that can be reached by employing the collection of steering vectors associated with Sᵢ.

The i^{th} row of the matrix M is associated with the i^{th} possible selection of K steering vectors 230, Sᵢ. The values of the elements in the i^{th} row of M correspond to how many of the members of each equivalence class can be reached by employing the steering vectors 230 in Sᵢ. Thus, different choices for steering vectors 230 can be compared across the rows of M. If a particular equivalent class represents reachable configurations that are very important to the designer, then a row in which the corresponding element is non-zero would match this requirement, whereas a row in which the element is zero implies that the corresponding equivalence class cannot be reached. The more important a particular equivalence class is to the designer, the higher the corresponding value in the row should be. For example, choosing a row (a choice of steering vectors) in which the value associated with a particular equivalence class is higher, compared to another choice, means that there are more ways for the architecture to arrive at a configuration associated with the desired equivalence class.

Because equivalence classes are of different sizes, it could be important to normalize the elements in M by dividing the elements in each column of M by the size of the corresponding equivalence class. In so doing, each element will be normalized to between zero and one, representing the fraction of the possible members of each equivalence class that can be reached by the choice of steering vectors 230. Thus, an ideal choice of a row (steering vectors) would correspond to a row of ones, meaning that all possible permutations are reachable. In a constrained design, however, it is desirable for K to be as small as possible, which inevitably translates to zero entries in the matrix M. Because it is assumed that the designer knows which configurations (i.e., equivalence classes) are important, and which ones are not, these requirements can be translated into a desired row of values. Selecting the best collection of steering vectors 230 then reduces to the problem of finding a row in M that is equal (or similar) to a row containing the desired values. Example 5.1 below shows the calculations associated with the process described in this section.

Example 5.1. Assume three functional units of type A, B, and C, each requiring 1, 2, and 3 slots, respectively. Also, assume a configuration space size of N=4 slots and that it is desired to use K=2 steering vectors.

First, generate the equivalence class representatives; in this case there are Q=4. These can be determined according to the method presented in [2]; they are given by:

V₁=(A₁,A₁,A₁,A₁)^{T}

V₂=(A₁,A₁,B₁,B₂)^{T}

V₃=(B₁,B₂,B₁,B₂)^{T}

V₄=(A₁,C₁,C₂,C₃)^{T} (5.7)

Next, generate the permutations (members) for each equivalence class to construct the universe U of all possible permutations:

$$\begin{matrix}[ {V}_{1} ] = \{ ( \begin{matrix}{A}_{1} \\ {A}_{1} \\ {A}_{1} \\ {A}_{1}\end{matrix} ) \} [ {V}_{2} ] = \{ ( \begin{matrix}{A}_{1} \\ {A}_{1} \\ {B}_{1} \\ {B}_{2}\end{matrix} ) , ( \begin{matrix}{A}_{1} \\ {B}_{1} \\ {B}_{2} \\ {A}_{1}\end{matrix} ) , ( \begin{matrix}{B}_{1} \\ {B}_{2} \\ {A}_{1} \\ {A}_{1}\end{matrix} ) \} & ( 5.8 ) \\ [ {V}_{3} ] = \{ ( \begin{matrix}{B}_{1} \\ {B}_{2} \\ {B}_{1} \\ {B}_{2}\end{matrix} ) \} [ {V}_{4} ] = \{ ( \begin{matrix}{A}_{1} \\ {C}_{1} \\ {C}_{2} \\ {C}_{3}\end{matrix} ) , ( \begin{matrix}{C}_{1} \\ {C}_{2} \\ {C}_{3} \\ {A}_{1}\end{matrix} ) \} & ( 5.9 )\end{matrix}$$

Because there are seven total vectors in the universe

$$U = {⋃}_{i ∈ \{ 1 , … , Q \}} [ {V}_{i} ] ,$$

and we are assuming K=2 steering vectors 230 are to be employed, there are

$$L = \frac{7 !}{( 7 - 2 ) ! 2 !} = 21$$

possible sets of steering vectors that need to be considered. For the sake of space, each independent set is not shown here; instead the completed matrix is shown in Equation (5.10).

For example, the steering vectors associated with the last row of M can only reach the two members of [V₄].

$$M = [ \begin{matrix}1 & 1 & 0 & 0 \\ 1 & 1 & 0 & 0 \\ 1 & 1 & 0 & 0 \\ 1 & 2 & 1 & 0 \\ 1 & 0 & 0 & 1 \\ 1 & 0 & 0 & 1 \\ 0 & 2 & 0 & 0 \\ 1 & 2 & 1 & 0 \\ 0 & 2 & 1 & 0 \\ 0 & 1 & 0 & 1 \\ 0 & 1 & 0 & 1 \\ 0 & 2 & 0 & 0 \\ 0 & 2 & 1 & 0 \\ 0 & 1 & 0 & 1 \\ 0 & 1 & 0 & 1 \\ 0 & 1 & 1 & 0 \\ 0 & 1 & 0 & 1 \\ 0 & 1 & 0 & 1 \\ 0 & 0 & 1 & 1 \\ 0 & 0 & 1 & 1 \\ 0 & 0 & 0 & 2\end{matrix} ] \qquad ( 5.10 )$$

Observe that if a collection of two steering vectors 230 existed that could reach at least one member of every equivalence class, there would be a row in M with all non-zero entries. Thus, because there is no such row, it is clear that all possible choices of two steering vectors 230 are unable to reach at least one configuration in every equivalence class. As mentioned above, the final choice (last row of M) of steering vectors 230 can reach only configurations in equivalence class [V₄]. The third row of the matrix corresponds to a choice of steering vectors that can reach a maximum number of configurations; however, this choice cannot reach configurations associated with the equivalence class [V₄]. Observe that if K is defined to be three or four (instead of two), then the number of rows in M would increase. If K is four, there will exist a row in the matrix in which the four steering vectors 230 are from each of the four equivalence classes; these four steering vectors 230 would able to reach all equivalence classes. But recall that allowing K to be large increases the hardware complexity associated with constructing the busses. The aim is to keep K as small as possible, and still arrive at a choice of steering vectors 230 that enable the architecture to reach desirable configurations. So, for the current example, if the configuration associated with [V₄] is never needed, then the steering vector choices associated with the fourth or eighth rows would be good design choices.

### Case Study

A general-purpose processor architecture with dynamically reconfigurable functional units was proposed in reference [3]. This basic concept was studied further and extended in references [1] and [2]. For the case study presented in this section, it is assumed that the reconfigurable processor has N=5 slots and that the objective is to design K=2 steering vectors that are well matched to the configurations determined to be important. The specific objective is to exploit as much instruction-level parallelism as possible by being able to reach important configurations, i.e., those configurations that enable as many instructions to be executed in parallel as possible. For example, if it is the case that multiplication instructions can never (or rarely) be executed in parallel, but parallel addition instructions can often be executed in parallel, then the choice of steering vectors 230 should comprehend this reality and enable configurations with two or more adder units to be reachable.

For the purposes of this study, the practical, yet application specific, techniques of code execution profiling and tracing are employed to identify important configurations. This approach is a practical off-line design strategy in which the implemented system has extreme performance requirements.

To identify the desired configurations for this study, a benchmark program is traced and potential instruction-level parallelism is analyzed by simulating the execution of the benchmark. In particular, the Susan benchmark from the Automotive and Industrial Control category of the MiBench set of embedded benchmarks was traced and analyzed—see reference [12].

Four functional units are considered that can be loaded in the reconfigurable resources. This collection of functional units is assumed to be capable of executing all of the instructions required by the benchmark. The functional unit descriptions and relative sizes are:

Integer Arithmetic Logic (IAL) Unit of size 1;

Integer Multiply Divide (IMD) Unit of size 2;

Floating Point Arithmetic Logic (FAL) Unit of size 2; and

Floating Point Multiply Divide (FMD) Unit of size 3.

In this simulation, instructions are placed in the instruction buffer 22 that can hold eight instructions. On each clock cycle, the instruction buffer 22 is analyzed; instructions that have no dependencies are removed from the buffer 22 and assigned to a functional unit. The simulation assumes ideal availability of the functional units required to exploit all of the parallelism present in the instruction buffer 22 during each cycle.

Ideal availability of functional units is equivalent to being able to reach any configuration necessary for exploiting the available instruction-level parallelism. Simulation of the temporal evolution of the instruction buffer 22 is used to determine which configurations of functional units provide the greatest advantage in terms of clock cycle time. Further analysis of available instruction-level parallelism at each clock cycle provides a means of determining the global importance of each configuration.

Table 2 shows the number of clock cycles during which each configuration must be utilized in order to exploit all of the available instruction-level parallelism. Note that Table 2 does not report the total number of cycles required to execute the program using a single configuration, i.e., all of the configurations listed in Table 2 were required for exploiting all of the instruction-level parallelism. The summation of values listed in the “Utilization” column of Table 2 represents the total number of cycles required to execute the program (assuming ideal parallelism). Furthermore, the values reported do not account for clock cycles devoted to reconfiguration time.

In Table 2, the available instruction-level parallelism associated with the first seven configurations are all satisfied by the configuration containing one FAL, one IMD, and one IAL. For example, the first configuration does not make parallel use of functional units; however, the single unit requirement (one FAL unit) is indeed a subset of the seventh configuration, which has three units and utilizes all N=5 slots of the reconfigurable resources. Thus, the configuration vector V₁=(FAL₁, FAL₂, IMD₁, IMD₂, IAL₁)^{T} represents configuration number 7 in Table 2, which covers the first seven entries in the table.

It is assumed here that important configurations can be identified based on the number of clock cycles required of a specific configuration, and that each functional unit is required to appear in at least one position among the steering vectors. The combinatorial technique presented herein can be used to design a set of steering vectors 230 to operate on the Susan benchmark.

Equation (5.11) is one example set of steering vectors obtained with the combinatorial technique introduced for K=2 steering vectors and N=5 reconfigurable slots.

$${s}_{1} = ( \begin{matrix}{FAL}_{1} \\ {FAL}_{2} \\ {IMD}_{1} \\ {IMD}_{2} \\ {IAL}_{1}\end{matrix} ) \\ {s}_{2} = ( \begin{matrix}{FMD}_{1} \\ {FMD}_{2} \\ {FMD}_{3} \\ {IAL}_{1} \\ {IAL}_{1}\end{matrix} ) \qquad ( 5.11 )$$

Generation of these steering vectors 230 was performed using execution times from Table 2, assuming that the goal of the design is to maximize possible instruction-level parallelism so as to improve the reconfigurable processor depicted in FIG. 1.

The combinatorial techniques presented herein provide a powerful method of generating steering vectors 230 that are then stored in a computer readable medium so as to be able to be utilized in reconfiguration the RFUs 14 of the reconfigurable processor depicted in FIG. 1 from specific design constraints. In addition, alternative methods of identifying the important configurations lend themselves well to this approach, as generation of the steering vector sets do not depend on the method used to assign importance to a configuration, i.e., rather than selecting configurations based solely on execution time and exploitation of parallelism, one could integrate the cost of reconfiguration in terms of power and/or time.

### CONCLUSIONS

In accordance with one aspect of the present invention, we have extended the work in references [1-3] by generalizing a framework for reconfiguration that considers the challenge of designing steering vectors 230 with respect to specific hardware constraints; namely, constraints related to the interconnection network (MUXs) between the reconfigurable resources and the steering vectors 230, and the size of the steering vectors 230. We have demonstrated a method by which a designer can determine the best possible set of steering vectors 230 given the functional unit information, the steering vector size, and the sizes of the multiplexers used in the interconnection network, i.e., K, the number of steering vectors 230 that can be supported.

The approach taken here is combinatorial and provides a consistent view of the configurable space, and as a measure of that space, the number of configurations that can be reached with the selection of a given set of steering vectors 230. Future work includes approaching this problem with optimization techniques, which may yield results without exhaustive combinatorial techniques.

### REFERENCES

Reference [1] Veale, B. F., Antonio, J. K., and Tull, M. P., “Configuration Steering for a Reconfigurable Superscalar Processor,” 12^{th} Reconfigurable Architectures Workshop (RAW 2005), Proceedings of the 19th International. Parallel and Distributed Processing Symosium (IPDPS 2005), Denver, Colo., April 2005.
Reference [2] Mould, N. M., Veale, B. F., Tull, M. P., and Antonio, J. K. “Dynamic Configuration Steering for a Reconfigurable Superscalar Processor,” 13^{th} Reconfigurable Architectures Workshop (RAW 2006), Rhodes Island, Greece, April 2006.
Reference [3] Niyonkuru, A. and Zeidler, H. C., “Designing a Runtime Reconfigurable Processor for General Purpose Applications,” Reconfigurable Architectures Workshop, in Proceedings of the 18^{th} International Symposium on Parallel and Distributed Processing, pp. 143-149, April 2004.
Reference [4] M. R. Garey and D. S. Johnson, Computers and Intractability: A Guide to the Theory of NP-Completeness, W. H. Freeman and Co., 1979.
Reference [5] Ahmad, I., Dhodhi, M. K., and UI-Mustafa, R., “DPS: dynamic priority scheduling heuristic for heterogeneous computing systems,” Computers and Digital Techniques, IEE Proceedings-Volume 145, Issue 6, pp. 411-418, November 1998.
Reference [6] Sih, G. C. and Lee, E. A., “A compile-time scheduling heuristic for interconnection-constrained heterogeneous processor architectures,” IEEE Transactions on Parallel and Distributed Systems, Vol. 4, Iss. 2, pp. 175-187, Feb. 1993.
Reference [7] Li Shang and Niraj K. Jha, “Hardware-Software Co-Synthesis of Low Power Real-Time Distributed Embedded Systems with Dynamically Reconfigurable FPGAs,” in Proceedings of the 15^{th} International Conference on VLSI Design, 2002.
Reference [8] Beckmann, C. J., and Polychronopoulos, C. D., “Microarchitecture Support For Dynamic Scheduling Of Acyclic Task Graphs,” in Proceedings of the 25th Annual International Symposium on Microarchitecture, pp. 140-148, December 1992.
Reference [9] E. Ilavarasan and P. Thambidurai, “Levelized Scheduling of Directed A-cyclic Precedence Constrained Task Graphs onto Heterogeneous Computing System,” in Proceedings of the First International Conference on Distributed Frameworks for Multimedia Applications, 2005.
Reference [10] Stewart, J., Calculus, Brooks-Cole, 5^{th} Edition, 2002, ISBN: 053439339X.
Reference [11] Eric W. Weisstein. “Cover.” From MathWorld—A Wolfram Web Resource. http://mathworld.wolfram.com/Cover.html
Reference [12] Guthaus, M. R., Ringenberg, D. E., Austin, T. M., et al, “MiBench: A Free, Commercially Representative Embedded Benchmark Suite,” Proceedings of the 4^{th} Annual IEEE Workshop on Workload Characterization, December 2001, pp. 3-14.
Reference [13] Francisco Barat and Rudy Lauwereins, “Reconfigurable Instruction Set Processors: A Survey,” Proceedings of the 11th International Workshop on Rapid System Prototyping, June 2000, pp. 168-173.
Reference [14] C. Iseli and E. Sanchez, “Beyond Superscalar Using FPGAs,” Proceedings of the 1993 IEEE International Conference on Computer Design: VLSI in Computers and Processors, 1993, pp. 486-490.
Reference [15] R. Razdan and M. D. Smith, “A High-Performance Microarchitecture with Hardware-Programmable Functional Units,” Proceedings of the 27th Annual International Symposium on Microarchitecture, 1994, pp. 172-180.
Reference [16] Veale, Brian F., “Reconfigurable Microprocessors: Instruction Set Selection, Code Optimization, and Configuration Control,” Ph. D. Dissertation, University of Oklahoma, 2005.
Reference [17] Veale, Brian F., Antonio, John, K., Tull, Monte P., “Configuration Steering for a Reconfigurable Superscalar Processor,” U.S. PCT International application Ser. No. 11/395,777. Mar. 31, 2006.
Reference [18] PowerPC, IBM, Armonk, N.Y. http://www-03.ibm.com/chips/power/powerpc/.
Reference [19] Hauser, J. R. and Wawrzynek, J., “Garp: A MIPS Processor with a Reconfigurable Coprocessor,” Proceedings of the 5th Annual IEEE Symposium on Field Programmable Custom Computing Machines, 1997, pp. 12-21.
Reference [20] Cardoso, J. M.; Simoes, J. B.; Correia, C. M. B. A.; Combo, A.; Pereira, R.; Sousa, J.; Cruz, N.; Carvalho, P.; Varandas, C. A. F., “A high performance reconfigurable hardware platform for digital pulse processing,” IEEE Transactions on Nuclear Science, June 2004, pp. 921-925.
Reference [21] Bishop, S. L.; Rai, S.; Gunturk, B.; Trahan, J. L.; Vaidyanathan, R., “Reconfigurable Implementation of Wavelet Integer Lifting Transforms for Image Compression,” IEEE International Conference on Reconfigurable Computing and FPGAs, September 2006.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

TABLE 1

| | Int- | Int- | | FP- | FP- |
|---|---|---|---|---|---|
| | ALU | MDU | LSU | ALU | MDU |
| FFUs | 1 | 1 | 1 | 1 | 1 |
| RFUs - Configuration 0 (Current) | 0-2 | 0-3 | 0-4 | 0-1 | 0-1 |
| RFUs - Configuration 1 | 1 | 1 | 4 | 0 | 0 |
| RFUs - Configuration 2 | 0 | 0 | 2 | 1 | 1 |
| RFUs - Configuration 3 | 2 | 2 | 0 | 0 | 0 |
| Resource Type Encoding, t | 000₂ | 001₂ | 010₂ | 011₂ | 100₂ |

TABLE 2

| CONFIGURATION | # OF UNITS OF EACH TYPE | | | | UTILIZATION |
|---|---|---|---|---|---|
| NUMBER | FMD | FAL | IMD | IAL | (CYCLES) |
| 1− | 0 | 1 | 0 | 0 | 14,687,394 |
| 2− | 0 | 0 | 1 | 0 | 8,073,949 |
| 3− | 0 | 0 | 0 | 1 | 5,305,970 |
| 4− | 0 | 1 | 0 | 1 | 4,831,781 |
| 5− | 0 | 1 | 1 | 0 | 3,927,892 |
| 6− | 0 | 0 | 1 | 1 | 2,197,350 |
| 7 | 0 | 1 | 1 | 1 | 1,761,679 |
| 8− | 0 | 2 | 0 | 0 | 1,345,299 |
| 9− | 0 | 1 | 0 | 2 | 999,982 |
| 10− | 0 | 0 | 0 | 2 | 392,283 |
| 11+ | 0 | 1 | 1 | 2 | 317,736 |
| 12− | 0 | 0 | 0 | 3 | 314,990 |
| 13− | 1 | 0 | 0 | 0 | 202,321 |
| 14 | 0 | 2 | 0 | 1 | 88,724 |
| 15+ | 0 | 2 | 0 | 2 | 81,216 |
| 16+ | 0 | 2 | 0 | 3 | 43,320 |
| 17− | 0 | 0 | 2 | 0 | 21,387 |
| 18− | 0 | 0 | 0 | 4 | 16,528 |
| 19 | 0 | 0 | 2 | 1 | 14,273 |
| 20+ | 2 | 0 | 0 | 0 | 8,378 |
| 21− | 1 | 0 | 0 | 1 | 7,426 |
| 22 | 1 | 1 | 0 | 0 | 5,219 |
| 23+ | 1 | 1 | 0 | 1 | 3,577 |
| 24+ | 0 | 3 | 0 | 1 | 2,952 |
| 25+ | 1 | 2 | 0 | 0 | 1,908 |
| 26+ | 1 | 1 | 0 | 2 | 1,890 |
| 27 | 1 | 0 | 0 | 2 | 1,704 |
| 28+ | 0 | 3 | 0 | 0 | 1,476 |
| 29 | 1 | 0 | 1 | 0 | 840 |
| 30+ | 2 | 0 | 0 | 1 | 830 |
| 31+ | 1 | 2 | 0 | 1 | 636 |
| 32− | 0 | 0 | 1 | 2 | 635 |
| 33 | 0 | 0 | 1 | 3 | 395 |
| 34+ | 1 | 0 | 0 | 3 | 388 |
| 35 | 0 | 1 | 0 | 3 | 323 |
| 36+ | 0 | 0 | 2 | 2 | 287 |
| 37+ | 3 | 0 | 0 | 0 | 31 |
| 38 | 0 | 0 | 0 | 5 | 19 |
| 39+ | 0 | 0 | 0 | 6 | 15 |
| 40+ | 0 | 0 | 1 | 4 | 3 |
| 41+ | 0 | 1 | 0 | 4 | 1 |

What is claimed is:

1. A reconfigurable processor, comprising:
a plurality of reconfigurable slots capable of forming reconfigurable execution units;
a memory storing a plurality of steering vector processing hardware configurations for configuring the reconfigurable execution units;
an instruction queue storing a plurality of instructions to be executed by at least one of the reconfigurable execution units;
a configuration selection unit analyzing the dependency of instructions stored in the instruction queue to determine an error metric value for each of the steering vector processing hardware configurations indicative of an ability of a reconfigurable slot configured with the steering vector processing hardware configuration to execute the instructions in the instruction queue, and choosing one of the steering vector processing hardware configurations based upon the error metric values; and
a configuration loader determining whether one or more of the reconfigurable slots are available and reconfiguring at least one of the reconfigurable slots with at least a part of the chosen steering vector processing hardware configuration responsive to at least one of the reconfigurable slots being available.

2. The reconfigurable processor of claim 1, further comprising a plurality of fixed execution units, and wherein each fixed execution unit is capable of executing one or more instruction type.

3. The reconfigurable processor of claim 1, wherein the reconfigurable slots have a current configuration comprised of the execution units currently configured into the reconfigurable slots and is dynamically represented as a steering vector processing hardware configuration, and at least one of the other steering vector processing hardware configurations is statically predefined.

4. The reconfigurable processor of claim 3, wherein the current configuration is a hybrid combination of two or more predefined steering vector processing hardware configurations, achieved over time, by loading one or more execution unit configurations contained in the predefined steering vectors.

5. The reconfigurable processor of claim 1, wherein the configuration selection unit comprises:
a plurality of unit decoders cooperating to retrieve the opcode of each instruction in the instruction queue that is ready for execution, and outputting a code indicating the type of functional unit required by the instruction whose opcode was decoded;
a plurality of resource requirement encoders receiving the codes from the unit decoders and determining the number of functional units of each type that are required to execute a grouping of the instructions in the instruction queue;
a plurality of configuration error metric generators cooperating to determine the error metric value for each of the steering vector processing hardware configurations;
a minimal error selection unit receiving the error metric values and choosing the steering vector processing hardware configuration based on the error metric value determined by the error metric generators.

6. The reconfigurable processor of claim 5, wherein the grouping of the instructions in the instruction queue includes all of the instructions in the instruction queue.

7. The reconfigurable processor of claim 3, wherein the configuration selection unit determines an error metric value for the current configuration.

8. The reconfigurable processor of claim 5, wherein the configuration error metric generators include a plurality of combinational divider circuits with each of the combinational divider circuits being pre-assigned to a particular type of functional unit.

9. The reconfigurable processor of claim 8, wherein each of the combinational divider circuits receive a shift code and a code indicative of the number of functional units that are required to execute a grouping of the instructions in the instruction queue.

10. The reconfigurable processor of claim 9, wherein at least one of the combinational divider circuits include a barrel shifter.

11. The reconfigurable processor of claim 3, wherein the configuration selection unit favors the current configuration by not choosing to reconfigure any of the reconfigurable slots.

12. A method for making a reconfigurable processor, comprising the steps of:
determining a number K of steering vectors having at least one functional unit, each of the functional units having a predetermined size, the steering vectors being selectively loadable into a plurality of reconfigurable slots having a predetermined configuration space size to form reconfigurable execution units;
generating equivalence class representatives based on the size of the functional units and the predetermined configuration space size of the reconfigurable slots;
selecting K of the equivalence class representatives to be designed steering vectors; and
making the reconfigurable processor having the designed steering vectors.

13. The method of claim 12, wherein the step of selecting K of the equivalence class representatives is defined further as the step of generating permutations for each equivalence class representatives to construct a universe U of possible permutations, and wherein the step of selecting K of the equivalence class representatives is defined further as selecting K of the equivalence class representatives from the universe U of possible permutations.

14. The method of claim 13, wherein the universe U of possible permutations is represented as a matrix M having rows and columns, and wherein the one of the rows and columns represent a set of steering vectors, and wherein the other one of the rows and columns is associated with an equivalence class.

15. A reconfigurable processor, comprising:
a plurality of reconfigurable slots capable of forming reconfigurable execution units;
a memory storing a plurality of independent execution units for configuring the reconfigurable execution units without predetermined assignment of the independent execution units with any particular reconfigurable slots;
an instruction queue storing a plurality of instructions to be executed by at least one of the reconfigurable execution units;
a configuration manager analyzing the instructions stored in the instruction queue and assigning an independent execution unit for loading into one or more contiguous reconfigurable slots having a size sufficient to load the independent execution unit; and
a configuration loader determining whether one or more of the reconfigurable slots are available and reconfiguring at least one of the reconfigurable slots with the independent execution unit.

16. The reconfigurable processor of claim 15, wherein the configuration manager includes a level analysis unit, and an RFU need calculation unit, wherein the level analysis unit determines the dependency of instructions stored in the instruction queue and the RFU need calculation unit determines the number and type of execution units for each level and outputting signals to the configuration loader to cause the loading of the types and quantities of execution units to be configured.

17. The reconfigurable processor of claim 16, wherein the level analysis unit and the RFU need calculation unit are operating simultaneously to determine the types and quantities of execution units to be configured.

18. The reconfigurable processor claim 15, further comprising one or more multiplexers, and wherein the configuration loader provides control signals to the one or more multiplexers indicative of a particular one of the execution units and an identification of one or more reconfigurable slots, wherein the one or more multiplexers load the particular one of the execution units into the identified one or more reconfigurable slots.

19. The reconfigurable processor claim 16, further comprising one or more multiplexers, and wherein the configuration loader provides control signals to the one or more multiplexers indicative of a particular one of the execution units and an identification of one or more reconfigurable slots, wherein the one or more multiplexers load the particular one of the execution units into the identified one or more reconfigurable slots.
